(19) United States
(12) Patent Application Publication
(10) Pub. No.: US 2015/0249354 A1
(43) Pub. Date: Sep. 3, 2015

(54) COMMUNICATION USING LOAD MODULATION

(71) Applicant: Infineon Technologies Austria AG, Villach (AT)

(72) Inventors: Cheow Guan Lim, Singapore (SG); Wolfgang Furtner, Furstenfeldbruck (DE)

(73) Assignee: Infineon Technologies Austria AG, Villach (AT)

(21) Appl. No.: 14/194,185

(22) Filed: Feb. 28, 2014

(51) Int. Cl. H02J 7/00

(52) U.S. Cl. CPC H02J 7/0052; H02J 2007/0062

(57) ABSTRACT

In one example, a method includes receiving, by a first device and from a second device, power via a power line of a cable connecting the first device to the second device, wherein receiving power comprises drawing, by the first device, current from the second device. The method may also include communicating, by the first device, with the second device via the power line, wherein communicating comprises adjusting, by the first device, the amount of current drawn by the first device.

### TECHNICAL FIELD

This disclosure relates to inter-device communication, and in particular, to inter-device communication using load modulation.

### BACKGROUND

Universal serial bus (USB) has evolved from a data interface capable of supplying limited power to a primary provider of power with a data interface. Today, many devices charge or get their power from USB ports contained in laptops, cars, aircraft, or even wall sockets. USB has become a ubiquitous power socket for many small devices such as cell phones, MP3 players and other hand-held devices. USB may fulfill user requirements of data transfer, but may also to provide the ability to power or charge devices without the need to load a driver on the devices.

Over time, power requirements of USB devices have increased. One result of the increase in power requirements is an increase in charge time for devices that utilize USB ports to charge batteries.

### SUMMARY

In general, the techniques described in this disclosure are related to using load modulation to enable inter-device communication over the bus voltage line of a USB cable. For example, a first device may use load modulation to communicate with a second device via a bus voltage line of a USB cable.

In one example, a method includes receiving, by a first device and from a second device, power via a power line of a cable connecting the first device to the second device, wherein receiving power comprises drawing, by the first device, current from the second device. In this example, the method also includes communicating, by the first device, with the second device via the power line, wherein communicating comprises adjusting, by the first device, the amount of current drawn by the first device.

In another example, a power consumer device includes a power converter configured to receive power from a power provider device via a power line of a cable connecting the power consumer device to the power provider device, wherein the power converter is configured to receive power by drawing current from the power provider device. In this example, the power consumer device also includes a communication module configured to communicate with the power provider device by adjusting the amount of current drawn by the power consumer device.

In another example, a power consumer device includes means for receiving, from a power provider device, power via a power line of a cable connecting the power consumer device to the power provider device, wherein the means for receiving power comprise means for drawing current from the power provider device. In this example, the power consumer device also includes means for communicating, with the power provider device via the power line, wherein the means for communicating comprise means for adjusting the amount of current drawn by the means for drawing current.

In another example, a method includes providing, by a power provider device and to a power consumer device, power via a power line a cable connecting the power consumer device to the power provider device, wherein providing power comprises providing, by a power converter of the power provider device, current to the power consumer device. In this example, the method also includes communicating, by the power provider device, with the power consumer device via the power line, wherein communicating comprises monitoring, by the power provider device, the amount of current drawn by the power consumer device.

In another example, a power provider device includes a power converter configured to provide power to a power consumer device via a power line a cable connecting the power consumer device to the power provider device, wherein the power converter is configured to provide power by at least providing current to the power consumer device. In this example, the power provider device also includes a communication module configured to communicate with the power consumer device via the power line, wherein the communication module is configured to communicate by at least monitoring the amount of current drawn by the power consumer device.

The details of one or more examples are set forth in the accompanying drawings and the description below. Other features, objects, and advantages of the features described herein will be apparent from the description and drawings, and from the claims.

### BRIEF DESCRIPTION OF DRAWINGS

FIG. 1 is a block diagram illustrating an example system for inter-device communication using load modulation over a power supply line, in accordance with one or more aspects of the present disclosure.

FIGS. 2A-2B are block diagrams illustrating examples of a system for inter-device communication using load modulation over a power supply line, in accordance with one or more aspects of the present disclosure.

FIGS. 3A-3B are block diagrams illustrating examples of a system for inter-device communication using load modulation over a power supply line, in accordance with one or more aspects of the present disclosure.

FIG. 4 is a graph illustrating example voltage levels of a power supply line used for inter-device communication using load modulation, in accordance with one or more aspects of the present disclosure.

FIG. 5 is a graph illustrating example voltage levels of a power supply line used for inter-device communication using load modulation, in accordance with one or more aspects of the present disclosure.

FIGS. 6A-6D are graphs illustrating example signals for inter-device communication over a power line, in accordance with one or more aspects of the present disclosure.

FIG. 7 is a graph illustrating example current levels of a pulse used for inter-device communication over a power line, in accordance with one or more aspects of the present disclosure.

FIG. 8 is a graph illustrating example error levels caused by a pulse used for inter-device communication over a power line, in accordance with one or more aspects of the present disclosure.

FIG. 9 is a graph illustrating example error levels caused a pulse used for inter-device communication over a power line, in accordance with one or more aspects of the present disclosure.

FIGS. 10A-10C are conceptual diagrams illustrating example transmission configurations for inter-device communication over a power line, in accordance with one or more aspects of the present disclosure.

FIG. 11 is a conceptual diagram illustrating an example frame configurations for inter-device communication over a power line, in accordance with one or more aspects of the present disclosure.

FIG. 12 is a conceptual diagram illustrating further details of a data packet portion of an example frame for inter-device communication over a power line, in accordance with one or more aspects of the present disclosure.

FIGS. 13A-13D are conceptual diagrams illustrating further details of a data portion of an example frame for inter-device communication over a power line, in accordance with one or more aspects of the present disclosure.

FIG. 14 is a conceptual diagram illustrating further details of a data check portion of an example frame for inter-device communication over a power line, in accordance with one or more aspects of the present disclosure.

FIGS. 15A-15B are conceptual diagrams illustrating further details the effects of the inversion bit on the data portion of an example frame for inter-device communication over a power line, in accordance with one or more aspects of the present disclosure.

FIG. 16 is a flowchart illustrating example operations of a first device communicating with a second device over a power line using load modulation, in accordance with one or more aspects of the present disclosure.

FIG. 17 is a flowchart illustrating example operations of a second device communicating with a first device over a power line using load modulation, in accordance with one or more aspects of the present disclosure.

### DETAILED DESCRIPTION

Modern devices utilize universal serial bus (USB) connections for both data interface and power exchange. As the requirements of modern devices have increased, more and more inter-device bandwidth is needed. However, direct use of the other data lines (i.e., positive data line D+ and negative data line D−) for certain communications may not be desirable.

Techniques according to this disclosure may enable communication between USB devices via a bus voltage line using load modulation. In some examples, a power consumer may communicate with a power consumer via a bus voltage line of a USB cable by adjusting the amount of current drawn from the power provider. In this way, additional communication bandwidth may be created between the power consumer and the power provider without interfering with the other data lines.

In general, the techniques described in this disclosure are related to using load modulation to enable inter-device communication over the bus voltage line of a USB cable. For example, a first device may use load modulation to communicate with a second device via a bus voltage line of a USB cable.

Additionally, the power provided over a standard USB connection is typically limited to 5V with a current limit of 2.5 A which yields approximately 15 W. However, in order to accommodate their increasing power demands, ever higher capacity batteries are being used to power mobile devices. For example, batteries having capacities of 5600 mAh to 10000 mAh are commonly found in modern mobile devices. The increase in battery capacity comes with a corresponding increase in the amount of time required to charge the battery. For examples, with a standard USB connection (i.e., 15 W) the charging time for a 5600 mAh battery is approximately 90 minutes and the charge time for a 10000 mAh battery is approximately 165 minutes. Power requirements are likely to increase even further with future devices.

Techniques according to this disclosure may enable two devices connected by a USB cable to negotiate various power characteristics of the connection via a bus voltage line of the USB cable. In some examples, the devices may negotiate the amount of power supplied over the connection. For instance, a power consuming device may communicate with a power providing device via the bus voltage line to request additional power. In this way, the amount of time required to charge a battery of the power consuming device may be reduced. Additionally, this may enable the power consuming device to operate at a higher power level.

As used in this disclosure, USB may refer to one of more USB specifications including past, current or future USB specifications. Some example USB specifications include USB 1.0, USB 1.1, USB 2.0, USB 3.0, USB 3.1, and USB Power Delivery (PD) 1.0. Future USB specifications will likely emerge.

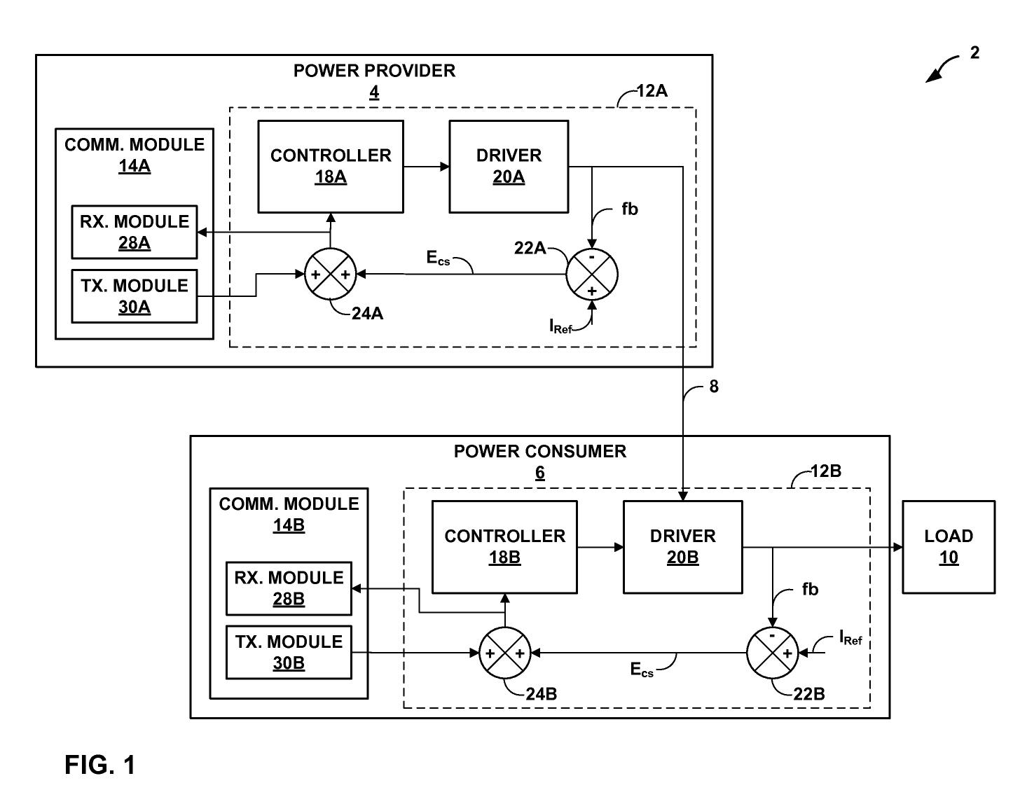

FIG. 1 is a block diagram illustrating an example system 2 for inter-device communication using load modulation over a power supply line, in accordance with one or more aspects of the present disclosure. As illustrated in the example of FIG. 1, system 2 may include power provider 4, power consumer 6, cable 8, and load 10.

System 2, in some examples, may include power provider 4. Power provider 4 may be configured to communicate with power consumer 6 via cable 8. In some examples, power provider 4 may include power converter 12A, and communication module 14A. Examples of power provider 4 may include, but are not limited to, power adapters (e.g., AC/DC adaptors such as so-called “wall warts,” power bricks, domestic mains adapters, line power adapters), desktop computers, laptop computers, mobile computing devices, cars, aircraft, wall sockets, cell phones, portable music players, DC/DC adaptors, or any other device capable of supplying power to another device. In some examples, power provider 4 may be integrated into a vehicle, such as an automobile, watercraft, aircraft, or any other type of vehicle. In some examples, power provider 4 may include a USB port configured to mate with a connector of cable 8. In other words, power provider 4 may be a USB device.

Power provider 4, in some examples, may include power converter 5. Power converter 12A may be configured to provide power to power consumer 6 via cable 8. In some examples, power converter 12A may include controller 18A, driver 20A, subtractor 22A, and adder 24A. In some examples, one or more components of power converter 12A may be arranged in a feedback loop. In the example of FIG. 1, controller 18A, driver 20A, subtractor 22A, and adder 24A are arranged in a feedback loop. Examples of power converter 12A include switched mode power converters such as buck, boost, buck-boost, flyback, Cuk, or any other type of device that can provide electrical power.

Power converter 12A, in some examples, may include controller 18A. Controller 18A may be configured to control the amount of power provided by power provider 4. In some examples, controller 18A may be configured to control the amount of power provided by outputting a control signal to driver 20A that causes driver 20A to output a particular amount of power. In some examples, controller 18A may be configured to control the amount of power based on an error signal received from subtractor 22A and/or adder 24A. Examples of controller 18A may include but are not limited to one or more processors, including, one or more microprocessors, digital signal processors (DSPs), application specific integrated circuits (ASICs), field programmable gate arrays (FPGAs), or any other equivalent integrated or discrete logic circuitry, as well as any combinations of such components.

In some examples, one or more components of power provider 4 may be included in controller 18A. For instance, one or more of subtractor 22A, adder 24A, and communication module 14A may be included in controller 18A. In some examples controller 18A may include analog-to-digital converters to enable controller 18A to send and receive one or more signals (e.g., the fb signal, the error signal, the control signal provided to driver 20A, etc. . . . ). In this way, the techniques of this disclosure may be implemented in a device, such as power provider 4 without the need for additional physical components. In other words, in some examples, the techniques of this disclosure may be implemented by updating the firmware of a device.

Power converter 12A, in some examples, may include driver 20A. Driver 20A may be configured to output power to power consumer 6. In some examples, the amount of power output by power consumer 6 may be based on a control signal received from controller 18A. In some examples, driver 20A may provide power to power consumer 6 by providing current to power consumer 6.

Power converter 12A, in some examples, may include subtractor 22A. Subtractor 22A may be configured to subtract a first value from a second value to determine a resulting value. For instance, subtractor 22A may be configured to subtract the current output from driver 20A from a reference current signal (i.e., I_{Ref}) to determine an error signal. Subtractor 22A may be configured to provide the determined error signal to adder 24A, controller 18A and/or communication module 14A.

Power converter 12A, in some examples, may include adder 24A. Adder 24A may be configured to add a first value to a second value to determine a resulting value. For instance, adder 24A may be configured to add the error signal received from subtractor 22A to a signal received from communication module 14A to determine a modified error signal.

Power provider 4 may, in some examples, include communication module 14A. Communication module 14A may be configured to communicate with an external device, such a power consumer 6. As illustrated in FIG. 1, communication module 14A may include RX module 28A which may be configured to receive information from power consumer 6, and TX module 30A which may be configured to transmit information to power consumer 6. In some examples, communication module 14A may be configured to receive data from power consumer 6 by monitoring the amount of current provided by power converter 12A. For instance, RX module 28A may be configured to monitor the amount of current provided by monitoring the error signal determined by subtractor 22A and/or adder 24A. In some examples, communication module 14A may be configured to monitor the amount of current provide by monitoring the output of power converter 12A. In some examples, communication module 14A may monitor the amount of current provided by determining that power consumer 6 has drawn one or more pulses of current. In some examples, communication module 14A may determine, based on the one or more pulses, that power consumer 6 has transmitted a symbol of a plurality of symbols. In some examples, communication module 14A may determine which symbol of the plurality of symbols was transmitted by determining that power consumer 6 did not draw a second pulse for a period of time after drawing a first pulse. In such examples, communication module 14A may determine which symbol of the plurality of symbols was transmitted based on the length of the period of time after the first pulse were power consumer 6 did not draw a second pulse.

In some examples, communication module 14A may be configured to transmit data to power consumer 6. For instance, TX module 30A may be configured to transmit information to power consumer 6 by adjusting the amount of current provided to power consumer 6. In some examples, TX module 30A may be configured to adjust the amount of current provided to power consumer 6 by sending a signal to adder 24A that causes power converter 12A to provide one or more pulses of current to power consumer 6.

System 2, in some examples, may include power consumer 6. Power consumer 6 may be configured to communicate with power provider 4. In some examples, power consumer 6 may be configured to receive power from power provider 4. In this way, power consumer 6 may be considered a load of power provider 4. In some examples, power consumer 6 may include power converter 12B, and communication module 14B. Examples of power consumer 6 may include, but are not limited to, desktop computers, laptop computers, mobile computing devices, vehicles, wall sockets, cell phones, portable music players, or any other device capable of receiving power from another device. In some examples, power consumer 6 may include a USB port configured to mate with a connector of cable 8. In other words, power consumer 6 may be a USB device.

Power consumer 6, in some examples, may include power converter 12B. Power converter 12B may be configured to receive power from power provider 4 and to provide power to load 10. In some examples, power converter 12B may include controller 18B, driver 20B, subtractor 22B, and adder 24B. Examples of power converter 12B may include switched mode power converters such as buck, boost, buck-boost, flyback, Cuk, or any other type of device that can provide electrical power.

Power converter 12B, in some examples, may include controller 18B. In some examples, controller 18B may be configured to perform functions similar to controller 18A of power converter 12A. For instance, controller 18B may be configured to control the amount of power received by power consumer 6 and provided to load 10. In some examples, controller 18B may be configured to control the amount of power received by outputting a control signal to driver 20B that causes driver 20B to output a particular amount of power. In other words, controller 18B may output a signal that controls the amount of current that driver 20B draws from power provider 4. In some examples, controller 18B may be configured to control the amount of power based on an error signal received from adder 24B. Examples of controller 18B may include but are not limited to one or more processors, including, one or more microprocessors, digital signal processors (DSPs), application specific integrated circuits (ASICs), field programmable gate arrays (FPGAs), or any other equivalent integrated or discrete logic circuitry, as well as any combinations of such components.

In some examples, one or more components of power consumer 6 may be included in controller 18B. For instance, one or more of subtractor 22B, adder 24B, and communication module 14B may be included in controller 18B. In some examples controller 18B may include analog-to-digital converters to enable controller 18B to send and receive one or more signals (e.g., the fb signal, the error signal, the control signal provided to driver 20B, etc. . . . ). In this way, the techniques of this disclosure may be implemented in a device, such as power provider 4 without the need for additional physical components. In other words, in some examples, the techniques of this disclosure may be implemented by updating the firmware of a device.

Power converter 12B, in some examples, may include driver 20B. In some examples, driver 20B may be configured to perform functions similar to driver 20A of power converter 12A. For instance, driver 20B may include a circuit or circuit element that may be configured to receive power from power provider 4 and provide power to load 10. In some examples, the amount of power output by driver 20B may be based on a control signal received from controller 18B. In some examples, driver 20B may receive power from power provider 4 by drawing current from power provider 4.

Power converter 12B, in some examples, may include subtractor 22B. Subtractor 22B may be configured to subtract a first value from a second value to determine a resulting value. For instance, subtractor 22B may be configured to subtract the current level output by driver 20B from a reference current signal (i.e., I_{Ref}) to determine an error signal. Subtractor 22B may be configured to provide the determined error signal to adder 24B.

Power converter 12B, in some examples, may include adder 24B. Adder 24B may be configured to add a first value to a second value to determine a resulting value. For instance, adder 24B may be configured to add the error signal received from subtractor 22B to a signal received from communication module 14B to determine a modified error signal.

Power consumer 6 may, in some examples, include communication module 14B. Communication module 14B may be configured to perform function similar to communication module 14A of power provider 4. For instance, communication module 14B may be configured to communicate with an external device such as power provider 4. As illustrated in FIG. 1, communication module 14B may include RX module 28B, and TX module 30B. In some examples, communication module 14B may be configured to transmit data to power provider 4 by adjusting the amount of current drawn by power converter 12B. In some examples, communication module 14B may be configured to adjust the amount of current provided by modifying the error signal determined by subtractor 22B. In some examples, communication module 14B may adjust the amount of current drawn by inserting one or more pulses into the amount of current drawn by power consumer 6. In some examples, communication module 14B may insert the one or more pulses by outputting a signal to adder 24B that causes adder 24B to modify the error signal. In some examples, communication module 14B may be configured to adjust the amount of current drawn by drawing current at the input of power provider 6. In other words, if power consumer 6 is regarded as a load of power provider 4, communication module 14B may communicate with power provider 4 by modulating the “load.”

In some examples, communication module 14B may be configured to receive data from power provider 4 by monitoring the amount of current received by power converter 12B. For instance, RX module 28B may be configured to monitor the amount of current received by monitoring the error signal determined by subtractor 22A and/or adder 24A.

In some examples, communication module 14B may be configured to communicate by transmitting at least one symbols of a plurality of symbols. In some examples, communication module 14B may be configured to transmit a symbol of the plurality of symbols by determining a period of time associated with the symbol, inserting a pulse in the amount of current drawn, and maintaining the amount of current drawn for a period of time. In other words, communication module 14B may insert a first pulse and refrain from inserting a second pulse for the period of time corresponding to the symbol to be transmitted. In some examples, each symbol of the plurality of symbols may correspond to a different period of time. In this way, communication module 14B may transmit data to power provider 4.

In some examples, one or more components of power provider 4 may be included in a processor, such as a microcontroller. For instance, one or more of subtractor 22B, adder 24B, communication module 14B and controller 18B may be included in a processor. In some examples, the processor may include analog-to-digital converters to enable the processor to send and receive the signals (e.g., the fb signal, the error signal, the control signal provided to driver 20B, etc. . . . ).

System 2, in some examples, may include cable 8. Cable 8 may be configured to couple power provider 4 to power consumer 6. In some examples, cable 8 may include a plurality of lines. For instance, cable 8 may include a power line, one or more data lines, and a ground line. In some examples, cable 8 may be a USB cable.

Load 10 may be coupled to power consumer 6. In some examples, load 10 may be included within power consumer 6. In some examples, load 10 may include one or more batteries, one or more computing devices, any other device that uses electrical power, or any combination of the same. Load 10 may be configured to receive input, such as electrical power, from other components of system 2, such as power converter 12B of power consumer 6. In some examples, such as where load 10 includes one or more batteries, load 10 may be configured to charge the one or more batteries with the electrical power received from the other components of system 2. Examples of load 10 may include computers (e.g., tablet or laptop computers), mobile computing devices (e.g., “smartphones,” and personal digital assistants), batteries (e.g., nickel-cadmium, lead-acid, nickel-metal hydride, nickel-zinc, silver-oxide, lithium-ion, or any other type of rechargeable battery), or any combination of the same.

As illustrated in the example of FIG. 1, power provider 4 may be connected to power consumer 6 via cable 8. In accordance with one or more techniques of this disclosure, power provider 4 may provide power to power consumer 6 via a power line of cable 8. For instance, power converter 12A of power provider 4 may provide current to power converter 12B of power consumer 6.

While power consumer 6 is drawing current from power provider 4, communication module 14B of power consumer 6 may communicate with communication module 14A of power provider 4 by adjusting the amount of power drawn from power converter 12A by power converter 12B. For instance, communication module 14B may adjust the amount of current drawn by power converter 12B by inserting one or more pulses into the amount of current drawn by power converter 12B. In other words, communication module 14B may insert additional error information into the control loop. Communication module 14B may wrap the data to be sent into a data frame and serialize the data. Communication module 14B may convert the individual bits to the error information. The inserted error may translate into more current pull/push into power consumer 6.

The current pulses drawn by power consumer 6 may result in changes in the amount of current provided by power provider 4. Therefore, by monitoring the amount of current provided to power consumer 6 by power provider 4 communication module 14A may communicate with power consumer 6. For instance, communication module 14A may determine that power consumer 6 has drawn one or more pulses of current. In other words, communication module 14A of power provider 4 may sense the load changes by monitoring the error information (E_{CS}) in the power regulation loop of power converter 5. In some examples, when TX module 30A is not transmitting, the output of adder 24A may be equal to the output of subtractor 22A. Communication module 14A may detect the symbols and decode the data.

In this way, as opposed to communicating over one of the data lines of cable 8, power consumer 6 may communicate with power provider 4 via a power line of cable 8.

In some examples, power provider 4 may transmit data to power consumer 6 using substantially the same method. For instance, TX module 30A of communication module 14A of power provider 4 may cause power converter 12A to provide one or more pulses of current to power consumer 6.

RX module 28B of communication module 14B of power consumer 6 may determine that TX module 30A has transmitted the one or more pulses of current by monitoring the output of adder 24B. Communication module 14B may detect the symbols and decode the data.

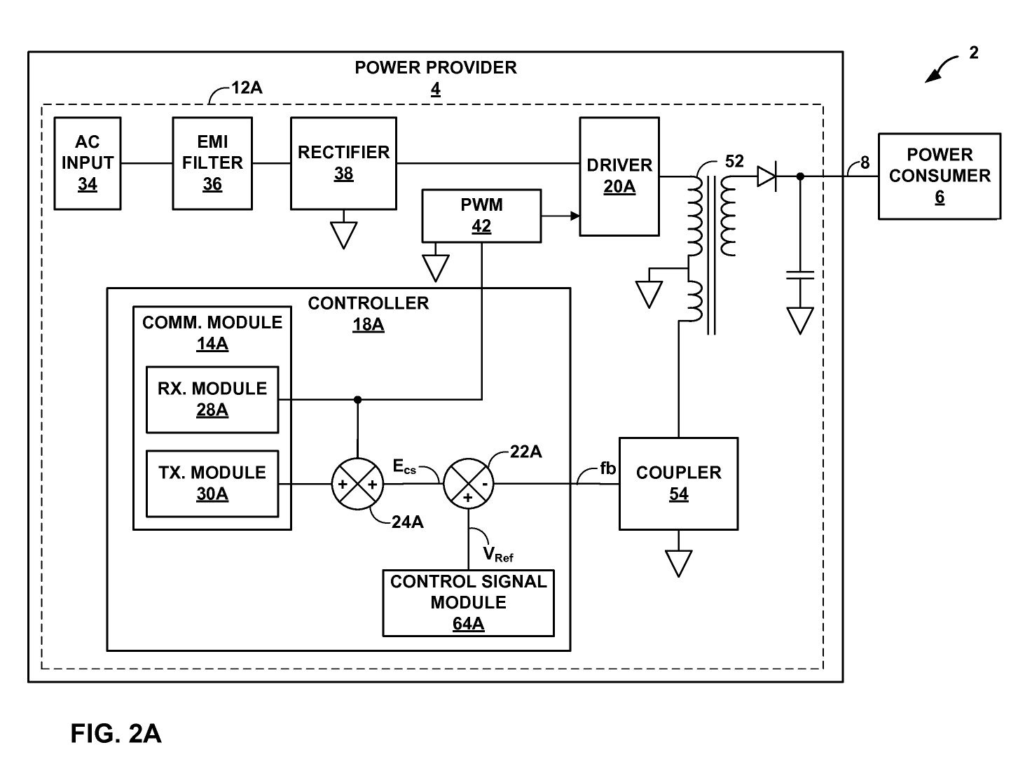

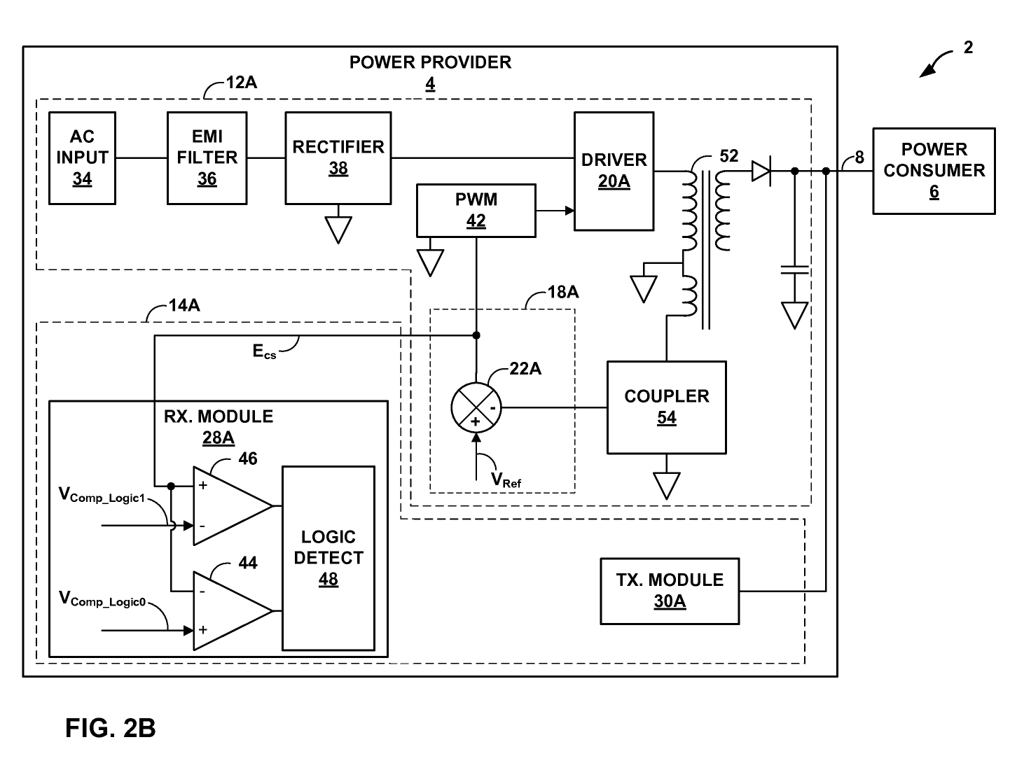

FIGS. 2A-2B are block diagrams illustrating examples of a system for inter-device communication using load modulation over a power supply line, in accordance with one or more aspects of the present disclosure. As illustrated in FIGS. 2A-2B, system 2 may include power provider 4, power consumer 6, and cable 8. Power provider 4, in some examples, may include power converter 12A and communication module 14A.

Power converter 12A may be configured to provide power to power consumer 6. In some examples, power converter 12A may include AC input 34, electromagnetic interference (EMI) filter 36, rectifier 38, driver 20A, pulse-width modulation (PWM) 42, transformer 52, controller 18A, and coupler 54.

Power converter 12A, in some examples, may include AC input 34. AC input 34 may be a mains voltage input configured to provide an AC power signal to EMC filter 36. For instance, AC input 34 may be a cable which may connect power provider 4 to a standard electrical outlet.

Power converter 12A, in some examples, may include EMI filter 36. EMI filter 36 may be configured to filter out (attenuate) any electromagnetic interference that may be present on the AC power signal received from AC input 34. EMI filter 36 may be configured to provide the filtered AC power signal to rectifier 38.

Power converter 12A, in some examples, may include rectifier 38. Rectifier 38 may be configured to convert an AC power signal into a DC power signal. For instance, rectifier 38 may be configured to convert the filtered AC power signal received from EMI filter 36 into a DC power signal and provide the DC power signal to driver 40.

Power converter 12A, in some examples, may include driver 20A. Driver 20A may be configured to provide power to power consumer 6 via transformer 52 and cable 8. In some examples, driver 20A may include one or more gates which may be controlled by a signal received from PWM 42. Alternatively, other types of modulation controllers could also be used, such as a pulse density modulation (PDM) controller or other type of controller that can control the gates of driver 20A. In some examples, the amount of power provided to power consumer 6 by driver 20A may be based on the control signal received from PWM controller 42. In some examples, driver 20A may include functionality similar to driver 20A of FIG. 1.

Power converter 12A, in some examples, may include PWM 42. PWM 42 may be configured to output a control signal to driver 40 that controls the amount of power driver 40 provides to power consumer 6. In some examples, PWM 42 may be configured to determine the control signal based on an error signal received from subtractor 50.

Power converter 12A, in some examples, may include controller 18A. Controller 18A may include functionality similar to controller 18A of FIG. 1. For instance, controller 18A may be configured to control the amount of power provided by power provider 4. In some examples, controller 18A may include communication module 14A, subtractor 22A, adder 24A, and control signal module 64A.

Controller 18A, in some examples, may include subtractor 22A. Subtractor 22A may include functionality similar to subtractor 22A of FIG. 1. For instance, subtractor 22A may be configured to subtract the output of coupler 54 from a reference voltage signal (i.e., V_{Ref}) to determine an error signal. Subtractor 22A may be configured to provide the determined error signal (i.e., E_{CS}) to adder 24A.

Controller 18A, in some examples, may include adder 24A. Adder 24A may include functionality similar to adder 24A of FIG. 1. For instance, adder 24A may be configured to add the error signal received from subtractor 22A to a signal received from communication module 14A to determine a modified error signal.

Controller 18A, in some examples, may include control signal module 64A. Control signal module 64A may include functionality to perform any variety of operations on controller 18A. For instance, control signal module 64 may be configured to output a signal (i.e., V_{Ref}) that causes power converter 12A to output power at V_{ref}.

Controller 18A, in some examples, may include communication module 14A. Communication module 14A may include functionality similar to communication module 14A of FIG. 1. For instance, communication module 14A may be configured to communicate with power consumer 6. In some examples, communication module 14A may include RX module 28A, and TX module 30A.

RX module 28A may be configured to receive data from an external device, such as power consumer 6. In some examples, RX module 28A may communicate with power consumer 6 by monitoring one or more aspects of power converter 12A. For instance, RX module 28A may be configured to monitor the amount of current provided by monitoring the error signal determined by subtractor 22A and/or adder 24A. In some examples, RX module 28A may be configured to communicate with power consumer 6 by decoding one or more symbols received from power consumer 6. For instance, RX module 28A may be configured to determine that power consumer 6 has drawn one or more pulses of current from power provider 4. In some examples, RX module 28A may determine that power consumer 6 has drawn a pulse of current by determining that a first amount of current was drawn by power consumer 6, determining that a second, different, amount of current was drawn by power consumer 6 for a pulse width period of time, and determining that, after the pulse width period of time, the first amount of current was drawn by the first device.

In some examples, RX module 28A may determine that the first amount of current was drawn by power consumer 6 in response to receiving a signal from adder 24A that indicates that the error signal is greater than a first threshold. In some examples, RX module 28A may determine that the second, different, amount of current was drawn by the power consumer in response to receiving a signal from adder 24A that indicates that the error signal is greater than a second threshold. In some examples, RX module 28A may determine that the second, different, amount of current was drawn by the power consumer in response to receiving a signal from adder 24A that indicates that the error signal is greater than the second threshold for period of time and then ceasing to receive the signal from adder 24A. In some examples, RX module 28A may determine that, after the pulse width period of time, the first amount of current was drawn by power consumer 6 in response to not receiving the signal from adder 24A that indicates that the error signal is greater than the first threshold.

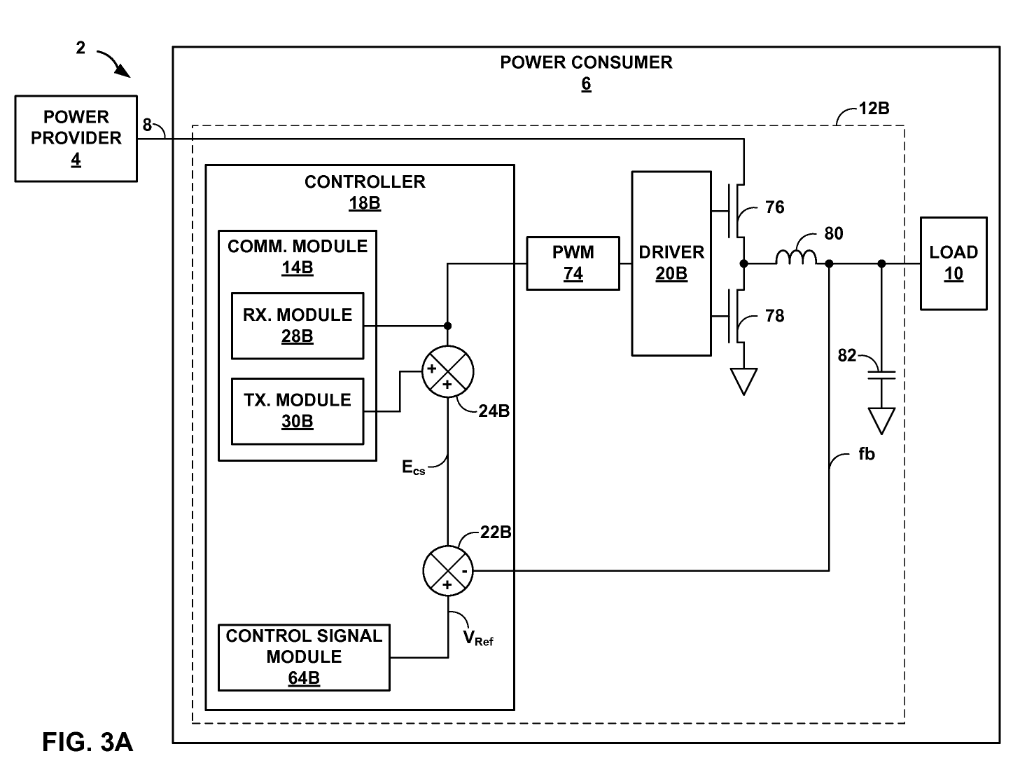

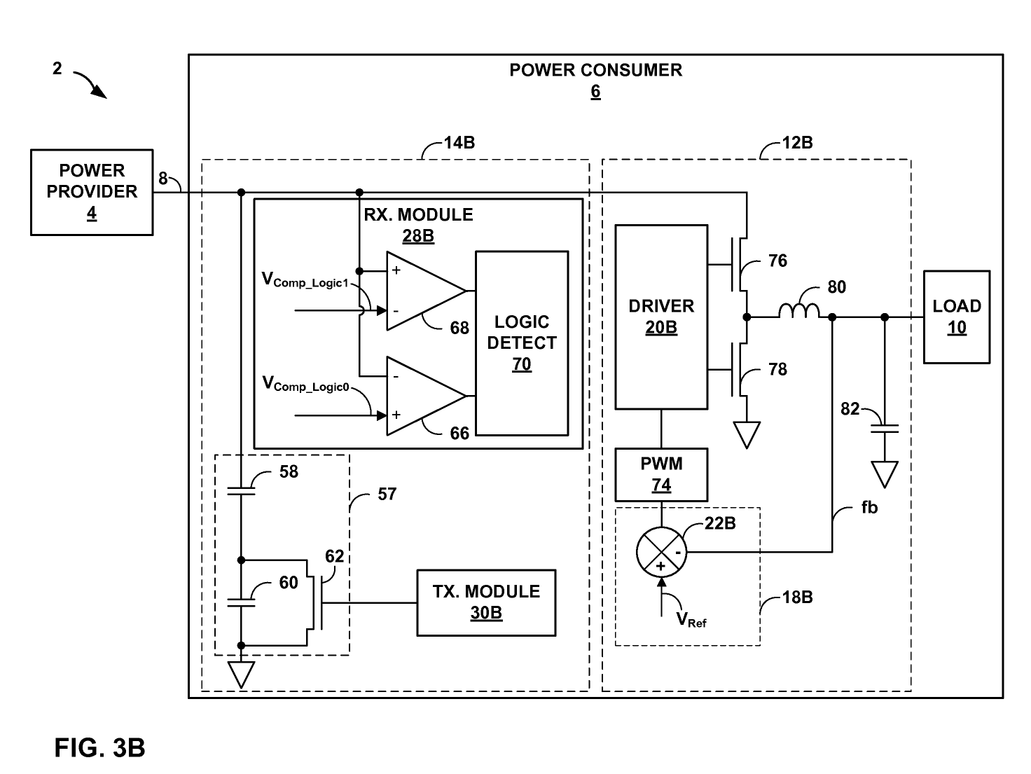

TX module 30A may be configured to transmit information to an external device, such as power consumer 6. In some examples, TX module 30A may transmit information by adjusting the amount of power provided to power consumer 6. TX module 30A may communicate with an external device using substantially the same techniques as TX module 30B, further details of which are discussed below with reference to FIGS. 3A-3B. For instance, TX module 30A may insert one or more pulses in the amount of power provided by adjusting the error signal determined by subtractor 22A by outputting a signal to adder 24A.

Power converter 12A, in some examples, may include transformer 52. In some examples, transformer 52 may be configured to scale the power provided by driver 40 before the power is provided to power consumer 6. In some examples, transformer 52 may be configured to electrically isolate power provider 4 from power consumer 6. In some examples, transformer 52 may include an additional winding which may be configured to scale the power provided by driver 20A before the power is provided to coupler 54.

Power converter 12A, in some examples, may include coupler 54. Coupler 54 may be configured to couple an output of transformer 52 with an input of controller 18A and/or subtractor 22A. In some examples, coupler 54 may be an opto-coupler.

Power provider 4 may be configured to provide power to power consumer 6 via a power line of cable 8. In some examples, driver 20A, transformer 52, coupler 54, controller 18A, and PWM 42 may form a feedback loop which may regulate the amount of power provided to power consumer 6. In some examples, driver 20A may receive the power to be provided to power consumer 6 from AC input 34 via EMI filter 36 and rectifier 38.

In accordance with one or more techniques of this disclosure, power provider 4 may also communicate with power consumer 6 via a power line of cable 8. In some examples, power provider 4 may receive data from power consumer 6 by monitoring the amount of current provided by power provider 4. In other words, power provider 4 may communicate with power consumer 6 by monitoring the amount of current drawn by power consumer 6.

In some examples, power consumer 6 may draw one or more pulses of current from power provider 4. The current pulses may result in disturbances in the error signal of the feedback loop. In other words, absent these current pulses, the error signal determined by subtractor 22A should be approximately zero.

The disturbed error signal may be received by adder 24 and/or RX module 28A. In some examples, absent any transmission signal from TX module 30A, the error signal received by RX module 28A may be substantially equal to the error signal received by adder 24A. RX module 28A may determine that power consumer 6 has started drawing a pulse of current where the error signal exceeds a first threshold. RX module 28A may determine that power consumer 6 is presently drawing a pulse of current where the error signal rises above a second threshold. RX module 28A may determine that the error signal exceeds the first threshold at a first time, determine that the error signal exceeds the second threshold at a second time, and determine that the error signal is less than the second threshold at a third time. In some examples, RX module 28A may determine a pulse width based on the difference between the first time and the third time. In some examples, the pulse width may be in the range of 0.45 ms to 0.55 ms. In some examples, the pulse width may be approximately 0.5 ms.

In some examples, RX module 28A may again determine that the error signal exceeds the first threshold at a fourth time. In some examples, RX module 28A may determine a symbol of a plurality of symbols based on the difference between the first time and the fourth time. In some examples, if the difference between the first time and the fourth time is in a first range, RX module 28A may determine that a logic 0 symbol has been received. In some examples, the first range may be from 2.5 ms to 3.5 ms. In some examples, if the difference between the first time and the fourth time is in a second range, RX module 28A may determine that a logic 1 symbol has been received. In some examples, the second range may be from 4.5 ms to 5.5 ms. In some examples, if the difference between the first time and the fourth time is in a third range, RX module 28A may determine that an end-of-frame symbol has been received. In some examples, the third range may be from 6.5 ms to 7.5 ms. In some examples, if the difference between the first time and the fourth time is in a fourth range, RX module 28A may determine that an end-of-transmission symbol has been received. In some examples, the fourth range may be from 8.5 ms to 9.5 ms. In other words, RX module 28A may receive information from power consumer 6 by determining the distance between subsequent load pulses.

In this way, as opposed to using data line of cable 8, power provider 4 may receive data from power consumer 6 via the power line of cable 8.

In some examples, the symbols determined by RX module 28A may include a request to modify one or more characteristic of the power line. In some examples, the one or more characteristics may include one or more of a voltage level for the power line and a current level for the power line. In some examples, in response to the request, logic detector may adjust at least one of the one or more characteristics of the power line. For instance, in response to a request to increase the voltage level for the power line, communication module 14A may cause control signal module 64 to adjust the V_{ref} input of subtractor 22A.

In some examples, such as the example of FIG. 2B, RX module 28A may include amplifier 44, amplifier 46, logic detector 48.

Amplifier 44 may be configured to compare a first signal with a second signal and output a resulting signal that indicates whether the first signal is greater than the second signal. For instance, amplifier 44 may be configured to compare the error signal received from subtractor 22A with a first threshold (i.e., V_{Comp}_{_{—}}_{Logic0}) to determine whether the error signal is greater than the first threshold. In response to determining that the error signal is greater than the first threshold, amplifier 44 may output a signal to logic detector 48 indicating the same.

Amplifier 46 may be configured to compare a first signal with a second signal and output a resulting signal that indicates whether the first signal is greater than the second signal. For instance, amplifier 46 may be configured to compare the error signal received from subtractor 22A with a second threshold (i.e., V_{Comp}_{_{—}}_{Logic1}) to determine whether the error signal is greater than the second threshold. In response to determining that the error signal is greater than the second threshold, amplifier 46 may output a signal to logic detector 48 indicating the same.

Logic detector 48 may be configured communicate with power consumer 6. In some examples, logic detector 48 may be configured to communicate with power consumer 6 using techniques similar to RX module 28A of FIG. 2A. For instance, logic detector 48 may receive data from power consumer 6 by decoding one or more symbols received from power consumer 6. For instance, logic detector 48 may be configured to determine that power consumer 6 has drawn one or more pulses of current from power provider 4. In some examples, logic detector 48 may determine that power consumer 6 has drawn a pulse of current by determining that a first amount of current was drawn by power consumer 6, determining that a second, different, amount of current was drawn by power consumer 6 for a pulse width period of time, and determining that, after the pulse width period of time, the first amount of current was drawn by the first device.

In some examples, logic detector 48 may determine that the first amount of current was drawn by power consumer 6 in response to receiving a signal from amplifier 44 that indicates that the error signal is greater than the first threshold. In some examples, logic detector 48 may determine that the second, different, amount of current was drawn by the power consumer in response to receiving a signal from amplifier 46 that indicates that the error signal is greater than the second threshold. In some examples, logic detector 48 may determine that the second, different, amount of current was drawn by the power consumer in response to receiving a signal from amplifier 46 that indicates that the error signal is greater than the second threshold for period of time and then ceasing to receive the signal from amplifier 46. In some examples, logic detector 48 may determine that, after the pulse width period of time, the first amount of current was drawn by power consumer 6 in response to not receiving the signal from amplifier 44 that indicates that the error signal is greater than the first threshold.

In some examples, logic detector 48 may be configured to communicate with power consumer 6 by receiving at least one symbol of a plurality of symbols. In some examples, logic detector 48 may be configured to receive a symbol of the plurality of symbols by determining that a pulse of current has been drawn by the first device, determining that another pulse of current was not drawn by the first device for a period of time, and determining the symbol of the plurality of symbols based on the period of time. In some examples, each symbol of the plurality of symbols may correspond to a different period. In this way, logic detector 48 may communicate with power consumer 6 using techniques similar to RX module 28A of FIG. 2A.

In some examples, power provider 4 may transmit data to power consumer 6 by adjusting the amount of power provided by power provider 4. In other words, power provider 4 may communicate with power consumer 6 by adjusting the amount of power provided to power consumer 6.

In some examples, TX module 30A may cause power converter 12A to provide one or more pulses of power to power consumer 6. In some examples, such as the example of FIG. 2A, TX module 30A may cause power converter 12A to provide one or more pulses of power to power consumer 6 by adjusting the error signal of the feedback loop. In some examples, such as the example of FIG. 2B, TX module 30A may cause power converter 12A to provide one or more pulses of power to power consumer 6 by outputting a signal onto cable. The pulses may be in the form of voltage changes on cable 8. In some examples, TX module 30A may transmit data using one or more pulses using techniques to TX module 30B, further details of which are provided below with reference to FIGS. 3A-3B. In other words, RX module 28A may transmit information to power consumer 6 by adjusting the distance between subsequent load pulses. In this way, power provider 4 may transmit data to power consumer 6.

FIGS. 3A-3B are block diagrams illustrating example systems for inter-device communication using load modulation over a power supply line, in accordance with one or more aspects of the present disclosure. As illustrated in FIGS. 3A-3B, system 2 may include power provider 4, power consumer 6, and cable 8. Power consumer 6, in some examples, may include load 10, power converter 12B, communication module 14B.

Power consumer 6, in some examples, may include power converter 12B. Power converter 12B may be configured to receive power from power provider 4 and provide at least a portion of the received power to load 10. In some examples, power converter 12B may include driver 20B, PWM 74, transistor 76, transistor 78, inductor 80, and capacitor 82. Examples of power converter 12B may include switched mode power converters such as buck, boost, buck-boost, flyback, Cuk, or any other type of device that can provide electrical power. In some examples, power converter 12B may include functionality similar to power converter 12B of FIG. 1. In some examples, driver 20B, transistor 76, transistor 78, inductor 80, subtractor 22B, and adder 24B may form a feedback loop which may regulate the amount of power provided to load 10.

Power converter 12B, in some examples, may include driver 20B. Driver 20B may be configured to control transistor 76 and transistor 78 to facilitate the transfer of power to load 10. In some examples, driver 20B may include functionality similar to driver 20A of FIG. 1.

Power converter 12B, in some examples, may include PWM controller 74. PWM 74 may be configured to output a control signal to driver 20B that controls the amount of power driver 20B provides to load 10. In some examples, PWM 74 may be configured to determine the control signal based on reference voltage V_{ref}. In some examples, PWM 74 may include functionality similar to PWM 42 of FIGS. 2A-2B.

Power converter 12B may include capacitor 82. Capacitor 82 may be configured to minimize variations in the average voltage provided to load 10. For instance, capacitor 82 may minimize variations in the average voltage provided to load 10 while power consumer 6 is communicating with power provider 4.

Power converter 12B, in some examples, may include controller 18B. Controller 18B may include functionality similar to controller 18B of FIG. 1. For instance, controller 18B may be configured to control the amount of current drawn by power consumer 6. In some examples, such as the example of FIG. 3A, controller 18B may include communication module 14B, subtractor 22B, adder 24B, and control signal module 64B.

Controller 18B, in some examples, may include subtractor 22B. Subtractor 22B may include functionality similar to subtractor 22B of FIG. 1. For instance, subtractor 22B may be configured to subtract the output of coupler 54 from a reference voltage signal (i.e., V_{Ref}) to determine an error signal. Subtractor 22B may be configured to provide the determined error signal (i.e., E_{cs}) to adder 24A.

Controller 18B, in some examples, may include adder 24B. Adder 24B may include functionality similar to adder 24B of FIG. 1. For instance, adder 24B may be configured to add the error signal received from subtractor 22B to a signal received from communication module 14B to determine a modified error signal.

Controller 18B, in some examples, may include control signal module 64B. Control signal module 64B may include functionality to perform any variety of operations on controller 18B. For instance, control signal module 64B may be configured to output a signal (i.e., V_{Ref}) that causes power converter 12B to output power at V_{ref}.

Controller 18B, in some examples, may include communication module 14B. Communication module 14B may include functionality similar to communication module 14B of FIG. 1. For instance, communication module 14B may be configured to communicate with power provider 4. In some examples, communication module 14B may include RX module 28B, and TX module 30B.

TX module 30B may be configured to transmit data to an external device, such as power provider 4. In some examples, TX module 30B may communicate with power provider 4 by causing one or more pulses of current to be drawn from power provider 4. In some examples, such as the example of FIG. 3A, TX module 30B may be configured to draw one or more pulses of current by outputting a signal to adder 24B that causes a disturbance in the feedback loop of power converter 12B. In some examples, such as the example of FIG. 3B, TX module 30B may be configured to draw one or more pulses of current by operating transmitter 57.

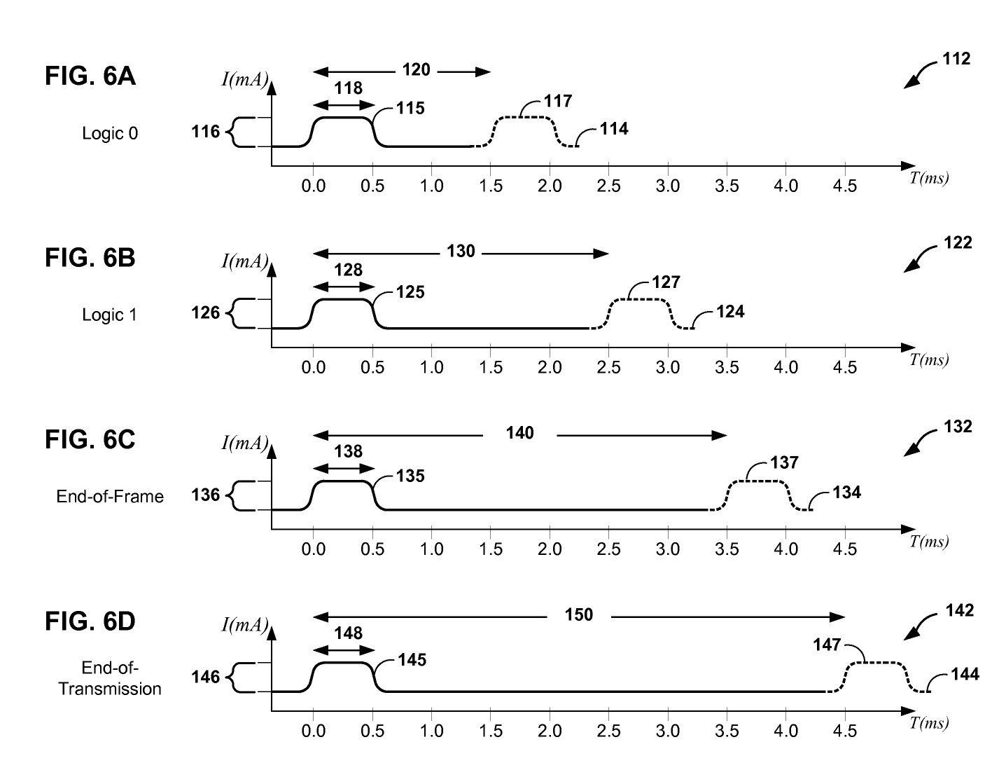

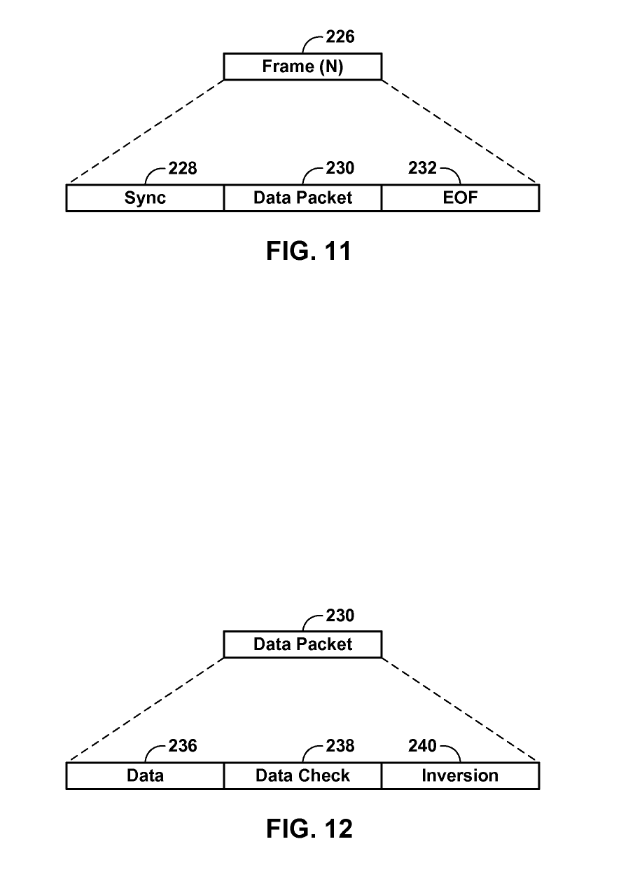

TX module 30B may be configured to encode a data stream according to a communication protocol. For instance, TX module 30B may be configured to encode a data stream by determining one or more symbols, such as the symbols described below with reference to FIGS. 6A-6D. In some examples, TX module 30B may be configured to encode the data stream into one or more frames, such as frame 226 described below with reference to FIG. 11. In some examples, TX module 30B may be configured to output a signal to transmitter 57 that causes transmitter 57 to transmit the encoded data stream to power provider 4 by modulating the amount of current power consumer 6 draws from power provider 4. In some examples, TX module 30B may be configured to output a signal to PWM 74 that causes PWM 74 to adjust the amount of current drawn from power provider 4. In some examples, such as where TX module 30B is included in controller 18B, power consumer 6 may not include transmitter 57 and TX module 30B may communicate by adjusting the signal provided to PWM 74.

RX module 28B may be configured to receive information from an external device, such as power provider 4. In some examples, RX module 28B may receive information by monitoring the amount of power received by power consumer 6. RX module 28B may communicate with an external device using substantially the same techniques as RX module 28A, further details of which are discussed above with reference to FIGS. 2A-2B. For example, RX module 28B may determine that power provider 4 has transmitted one or more pulses my monitoring a feedback loop of power converter 12B. As another example, RX module 28B may determine that power provider 4 has transmitted one or more pulses my monitoring a voltage level of cable 8.

Power consumer 6 may receive power from power provider 4 via a power line of cable 8. In some examples, power converter 12B may use the received power to provide power to load 10. For instance, where load 10 is a battery, power converter 12B may use the received power to charge the battery of load 10.

In accordance with one or more techniques of this disclosure, power consumer 6 may communicate with power provider 4 via the power line of cable 8. In some examples, power consumer 6 may communicate with power provider 4 by adjusting the amount of current drawn. In some examples, TX module 30B of power consumer 6 may adjust the amount of current drawn by sending a signal to transmitter 57 that causes transmitter 57 to draw a pulse of current from power provider 4. In some examples, TX module 30B may adjust the amount of current drawn by sending a signal to adder 24B that causes PWM 74 to adjust the control signal provided to driver 20B such that one or more pulses of current are drawn from power provider 4. In some examples, TX module 30B may receive data to be transmitted to power provider 4. In some examples, the data to be transmitted may include one or more symbols (e.g., logic 0, logic 1, end-of-frame, and end-of-transmission).

TX module 30B may encode the one or more symbols into one or more pulses of current. For instance, TX module 30B may transmit a symbol by transmitting a first pulse and then maintaining the amount of current drawn for a period of time corresponding to the symbol. In some examples, each symbol may correspond to a unique period of time.

In this way, as opposed to using any data lines of cable 8, power consumer 6 may send data to power provider 4 via the power line of cable 8.

In some examples, the data transmitted by TX module 30B may include a request to modify one or more characteristics of the power line of cable 8. In some examples, the one or more power characteristics may include a voltage level for the power line and a current level for the power line. In some examples, such as where load 10 includes a battery, power consumer 6 may request a higher voltage level which, if granted, may enable power consumer 6 to reduce the amount of time required to charge the battery of load 10.

In some examples, such as the example of FIG. 3B, RX module 28B may include amplifier 66, amplifier 68, logic detector 70.

RX module 28B, in some examples, may include amplifier 66. Amplifier 66 may be configured to compare a first signal with a second signal and output a resulting signal that indicates whether the first signal is greater than the second signal. For instance, amplifier 66 may be configured to compare the voltage of the power signal received from power provider 4 with a first threshold (i.e., V_{Comp}_{_{—}}_{Logic0}) to determine whether the voltage is greater than the first threshold. In response to determining that the voltage is greater than the first threshold, amplifier 66 may output a signal to logic detector 70 indicating the same.

RX module 28B, in some examples, may include amplifier 68. Amplifier 68 may be configured to compare a first signal with a second signal and output a resulting signal that indicates whether the first signal is greater than the second signal. For instance, amplifier 68 may be configured to compare the voltage of the power signal received from power provider 4 with a second threshold (i.e., V_{Comp}_{_{—}}_{Logic1}) to determine whether the voltage is greater than the second threshold. In response to determining that the voltage is greater than the second threshold, amplifier 68 may output a signal to logic detector 70 indicating the same.

RX module 28B, in some examples, may include logic detector 70. Logic detector 70 may be configured to decode one or more symbols received from power provider 4. For example, where amplifier 66 determines that the voltage of the power signal received from the amplifier is less than the first threshold, logic detector 70 may determine that a logic 0 symbol has been received. As another example, where amplifier 68 determines that the voltage of the power signal received from the amplifier is greater than the second threshold, logic detector 70 may determine that a logic 1 symbol has been received. In this way, logic detector 70 may communicate with power consumer 6 using techniques similar to RX module 28B of FIG. 3A.

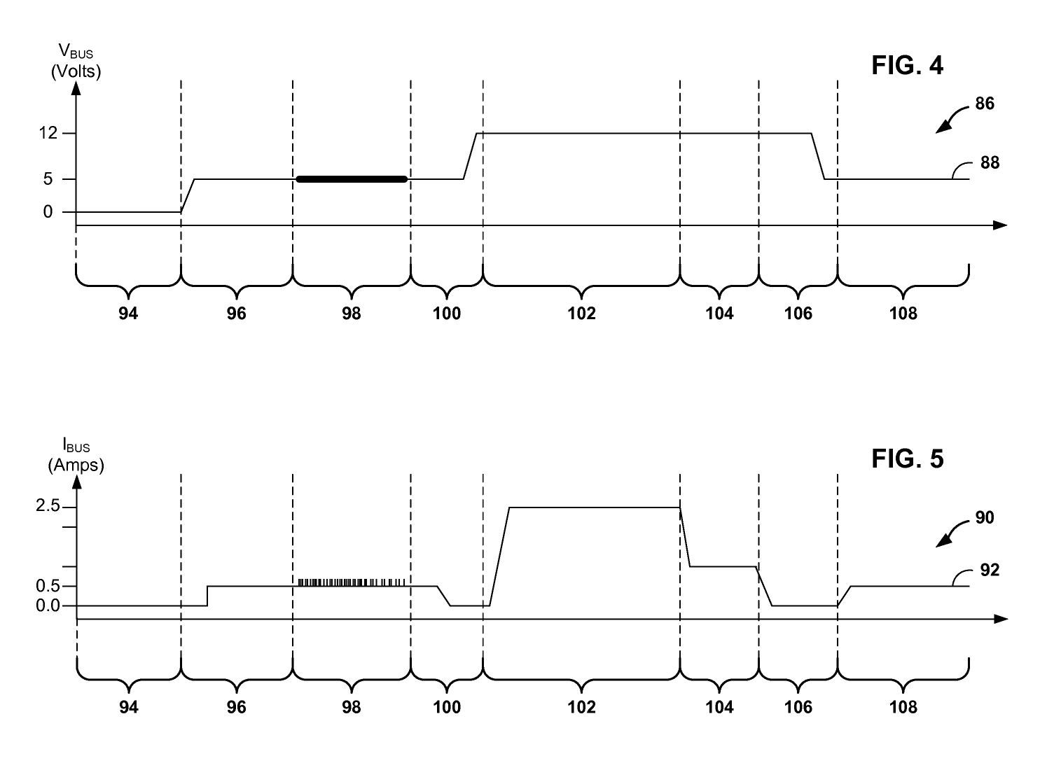

FIG. 4 is a graph illustrating example voltage levels of a power supply line used for inter-device communication using load modulation, in accordance with one or more aspects of the present disclosure. As illustrated by FIG. 4, graph 86 may include a horizontal axis representing time, a vertical axis representing a bus voltage (i.e., the voltage of a power supply line used for inter-device communication using load modulation), and plot 88 representing an example relationship between bus voltage and time of a power supply during time periods 94-108.

FIG. 5 is a graph illustrating example current levels of a power supply line used for inter-device communication using load modulation, in accordance with one or more aspects of the present disclosure. As illustrated by FIG. 5, graph 90 may include a horizontal axis representing time, a vertical axis representing a bus current (i.e., the current of a power supply line used for inter-device communication using load modulation), and plot 92 representing an example relationship between bus current and time of a power supply during time periods 94-108.

Referring to both FIG. 4 and FIG. 5, in some examples, a first end of the power supply line may be connected to a power provider and a second end of the power supply end may be connected to a power consumer. During time period 94, the power provider and/or the power consumer may be off. As illustrated by plot 88 and plot 92, the bus voltage and the bus current may both be zero.

During time period 96, the link between the power provider and the power consumer may become active and the power provider may begin to provide power to the power consumer. As illustrated by plot 88, the power provider may provide an initial voltage level of 5V. Additionally, during time period 96, the power consumer may begin to draw current. As illustrated by plot 92, the power consumer may begin to draw current at an initial current level of 0.5 A.

During time period 98, the power consumer may communicate with the power provider using load modulation. As illustrated by plot 92, the power consumer may draw a series of pulses of current from the power provider. In some examples, the power consumer may send a request for additional power to the power provider using load modulation. In some examples, the power consumer may request additional power to reduce the charging time of a battery attached to the power consumer. As illustrated by plot 88, in some examples, these current pulses may induce some changes in the voltage levels. However, also as illustrated by plot 88, these changes may be small and have minimal effect on the power provider and/or power consumer. If there may be any effect of lower or higher current on the power provided, the voltage of plot 88 may be changed (e.g., slightly changed) to maintain the power provided.

During time period 100, after the power consumer has completed transmission of the request for additional power, the power consumer may reduce the amount of current drawn below a threshold level. In some examples, by reducing the amount of current drawn below the threshold level, the power consumer may indicate to the power provider that it has ceased transmitting and is awaiting additional power. As illustrated by plot 92, in some examples, the power consumer may reduce the amount of current drawn to zero. In some examples, the reduction to zero may enable the power provider to change voltage levels without severe disturbances to the power converters.

Also during time period 100, the power provider may decode the information. In some examples, the power provider may decode the information in response to the current falling below the threshold. If the requested amount of power (i.e., voltage level and current level) can be provided, the power provider may increase the voltage to the desired level. As illustrated in FIG. 4 the power provider may increase the voltage to 12V. In some examples, increasing the output voltage by the power provider is the acknowledgement that it has accepted the request. In such examples, if the power provider does not increase the output voltage level, the power consumer may re-transmit the request. In some examples, the number of re-transmissions may be limited.

During time period 102, in response to the increase in voltage level, the power consumer may begin to draw current at the higher voltage level. As illustrated by plot 88 and plot 92, the power provider may provide and the power consumer may draw 2.5 A of current at 12V. While drawing current at the higher voltage level, the power consumer may, in some examples, launch a new request for a different voltage. However, in some of such examples, the power consumer may need to first lower its current draw below the threshold level in order to trigger the power provider to decode the request. In some examples, as long as the power consumer maintains a current draw above the threshold level, the power provider may maintain the voltage level.

However, during time period 104, the power consumer may desire to return to a lower power level. In some examples, the power consumer may desire to return to the lower voltage level when the power consumer has completed charging the battery attached to the power consumer. In some examples, to communicate the change in power to the power provider, the power consumer may reduce the amount of current drawn. As illustrated by plot 92, the power consumer may reduce the amount of current drawn to zero amps. In some examples, the power consumer may reduce the amount of current drawn below the high power level but above the threshold level. In the example of FIG. 5, the power consumer may reduce the amount of current drawn to 1 A. In some examples, to communicate the change in power to the power provider, the power consumer may draw a series of current pulses from the power provider. In some examples, the pulses may be similar to the pulses sent during time period 98.

During time period 106, the power consumer may then reduce the amount of current drawn to zero. Also during time period 106, in response to the reductions of current draw by the power consumer and/or the pulses received from the power consumer, the power provider may determine that the power consumer is attempting to return to a lower power level and reduce the voltage to a lower level. In some examples, the lower level may be the initial voltage level. As illustrated by plot 88, the power provider may begin to provide power at 5V.

During time period 108, in response to the power provider returning to the lower power level, the power consumer may resume drawing power at the lower power level. As illustrated by plot 92, the power consumer may draw 0.5 A at 5V.

FIGS. 6A-6D are graphs illustrating example signals for inter-device communication over a power line, in accordance with one or more aspects of the present disclosure.

As illustrated by FIG. 6A, graph 112 may include a horizontal axis representing time, a vertical axis representing current, and plot 114 illustrating a relationship between current and time that corresponds to an example logic 0 signal. Plot 114 may include first pulse 115 and second pulse 117. In some examples, first pulse 115 and second pulse 117 may have amplitude 116. In some examples, first pulse 115 and second pulse 117 may have different amplitudes. In some examples, first pulse 115 and second pulse 117 may have pulse width 118.

In accordance with one or more techniques of this disclosure, a power consumer may transmit a logic 0 symbol by drawing first pulse 118, and after drawing first pulse 118, maintaining the amount of current drawn for period of time 120. As illustrated in the example of FIG. 6A, period of time 120 may be approximately 1.5 ms. In some examples, after the expiration of period of time 120, the power consumer may transmit another symbol which may begin with second pulse 117.

As illustrated by FIG. 6B, graph 122 may include a horizontal axis representing time, a vertical axis representing current, and plot 124 illustrating a relationship between current and time that corresponds to an example logic 1 signal. Plot 124 may include first pulse 125 and second pulse 127. In some examples, first pulse 125 and second pulse 127 may have amplitude 126. In some examples, first pulse 125 and second pulse 127 may have different amplitudes. In some examples, first pulse 125 and second pulse 127 may have pulse width 128.

In accordance with one or more techniques of this disclosure, a power consumer may transmit a logic 1 symbol by drawing first pulse 128, and after drawing first pulse 128, maintaining the amount of current drawn for period of time 130. As illustrated in the example of FIG. 6B, period of time 130 may be approximately 2.5 ms. In some examples, after the expiration of period of time 130, the power consumer may transmit another symbol which may begin with second pulse 127.

As illustrated by FIG. 6C, graph 132 may include a horizontal axis representing time, a vertical axis representing current, and plot 134 illustrating a relationship between current and time that corresponds to an example end-of-frame signal. Plot 134 may include first pulse 135 and second pulse 137. In some examples, first pulse 135 and second pulse 137 may have amplitude 136. In some examples, first pulse 135 and second pulse 137 may have different amplitudes. In some examples, first pulse 135 and second pulse 137 may have pulse width 138.

In accordance with one or more techniques of this disclosure, a power consumer may transmit an end-of-frame symbol by drawing first pulse 138, and after drawing first pulse 138, maintaining the amount of current drawn for period of time 140. As illustrated in the example of FIG. 6C, period of time 140 may be approximately 3.5 ms. In some examples, after the expiration of period of time 140, the power consumer may transmit another symbol which may begin with second pulse 137.

As illustrated by FIG. 6D, graph 142 may include a horizontal axis representing time, a vertical axis representing current, and plot 144 illustrating a relationship between current and time that corresponds to an example end-of-transmission signal. Plot 144 may include first pulse 145 and second pulse 147. In some examples, first pulse 145 and second pulse 147 may have amplitude 146. In some examples, first pulse 145 and second pulse 147 may have different amplitudes. In some examples, first pulse 145 and second pulse 147 may have pulse width 148.

In accordance with one or more techniques of this disclosure, a power consumer may transmit an end-of-transmission symbol by drawing first pulse 148, and after drawing first pulse 148, maintaining the amount of current drawn for period of time 150. As illustrated in the example of FIG. 6D, period of time 150 may be approximately 4.5 ms. In some examples, after the expiration of period of time 150, the power consumer may transmit another symbol which may begin with second pulse 147.

While illustrated in FIGS. 6A-6D as beginning at the leading edge of the first pulse, in some examples, the time period may begin at some other point. For instance, the time period may begin at the trailing edge of the pulse, when the current crosses a threshold, etc. Also, while illustrated in FIGS. 6A-6D as being the same width, in some examples, the first pulse of the varying symbols may be of varying widths. For instance, in some examples, the pulse width of the first pulse of the logic 0 symbol (i.e., first pulse 115) may be shorter than the pulse width of the first pulse of the logic 1 symbol (i.e., first pulse 125). In this way, the power provider may be able to more easily discriminate between symbols which may reduce the error rate.

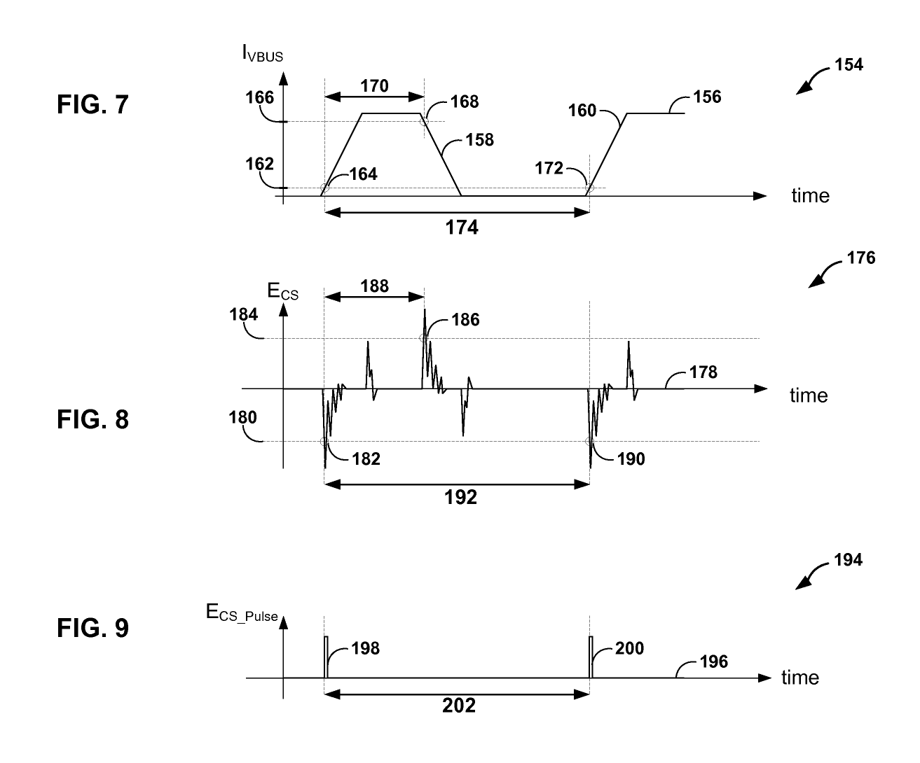

FIG. 7 is a graph illustrating example current levels of a pulse used for inter-device communication over a power line, in accordance with one or more aspects of the present disclosure. As illustrated by FIG. 7, graph 154 may include a horizontal axis representing time, a vertical axis representing current, and plot 156 illustrating a relationship between current and time corresponding to a pulse. Plot 156 may include first pulse 158 and second pulse 160. The current levels illustrated by plot 156 may, in some examples, correspond to fb of FIG. 1 and/or the output of coupler 54 of FIG. 2.

In accordance with one or more techniques of this disclosure, a power consumer may communicate with a power provider by drawing one or more pulses of current from the power provider. As illustrated by FIG. 7, in some examples, when the current plot 156 crosses first threshold 162 at point 164, the power provider may determine that the power consumer has started to draw a pulse of current. In some examples, first threshold 162 may correspond to 10% of the load modulation current. In some examples, the load modulation current may be approximately 100 mA. Then, in some examples, when the current plot 156 crosses second threshold 168 after plateauing, the power provider may determine that the power consumer has completed drawing the pulse of current. In some examples, second threshold 162 may correspond to 90% of the load modulation current. In some examples, the power provider may determine time period 170 as the time between point 164 and point 168. In some examples, based on this determined time period, the power provider may determine which symbol was transmitted by the power consumer.

Then, in some examples, when the current plot 156 again exceeds first threshold 162 as point 172, the power provider may determine that the power consumer has started to draw another pulse of current. In some examples, the power provider may determine time period 174 as the time between point 164 and 172. In some examples, based on this determined time period, the power provider may determine which symbol was transmitted by the power consumer. In some examples, the power provider may determine the symbol based on both time period 170 and time period 174.

FIG. 8 is a graph illustrating example error levels caused by a pulse used for inter-device communication over a power line, in accordance with one or more aspects of the present disclosure. As illustrated by FIG. 8, graph 176 may include a horizontal axis representing time, a vertical axis representing an error signal, and plot 178 illustrating a relationship between the error signal and time corresponding to a pulse. The error levels illustrated by plot 178 may, in some examples, correspond to E_{cs} of FIG. 1 and/or E_{cs} of FIG. 2.

In accordance with one or more techniques of this disclosure, a power consumer may communicate with a power provider by drawing one or more pulses of current from the power provider. In some examples, by drawing the one or more pulses of current, the power consumer may induce a corresponding change in the error signal of the power provider. As illustrated by FIG. 8, in some examples, when the error signal plot 178 crosses first threshold 180 at point 182, the power provider may determine that the power consumer has started to draw a pulse of current. In some examples, first threshold 180 may be referred to as E_{CS-tau}_{_{—}}ₛₜₐᵣₜ. In some examples, first threshold 180 may correspond to the error signal induced by 10% of the load modulation current. Then, in some examples, when the error signal plot 178 crosses second threshold 184, the power provider may determine that the power consumer has completed drawing the pulse of current. In some examples, first threshold 180 may be referred to as E_{CS-tau}_{_{—}}_{end}. In some examples, second threshold 186 may correspond to the error signal induced by 90% of the load modulation current. In some examples, the power provider may determine time period 188 as the time between point 182 and point 186. In some examples, based on this determined time period, the power provider may determine which symbol was transmitted by the power consumer.

Then, in some examples, when the error signal plot 178 again crosses first threshold 180 as point 190, the power provider may determine that the power consumer has started to draw another pulse of current. In some examples, the power provider may determine time period 192 as the time between point 182 and 190. In some examples, based on this determined time period, the power provider may determine which symbol was transmitted by the power consumer. In some examples, the power provider may determine the symbol based on both time period 188 and time period 192.

FIG. 9 is a graph illustrating example error levels caused a pulse used for inter-device communication over a power line, in accordance with one or more aspects of the present disclosure. As illustrated by FIG. 9, graph 176 may include a horizontal axis representing time, a vertical axis representing an error signal, and plot 178 illustrating a relationship between the error signal and time corresponding to a pulse.

In accordance with one or more techniques of this disclosure, a power consumer may communicate with a power provider by drawing one or more pulses of current from the power provider. In some examples, by drawing the one or more pulses of current, the power consumer may induce a corresponding change in the error signal of the power provider. In some examples, the power converter may filter the error signal (e.g., plot 178) to determine plot 196. As illustrated by FIG. 9, first pulse 198 and second pulse 200 are the result of plot 178 crossing below first threshold 180. In other words, the power provider may determine that first pulse 198 occurs at approximately the same time as point 182 and second pulse 200 occurs at approximately the same time as point 190. In some examples, the power provider may determine time period 202 as the time between first pulse 198 and second pulse 200. In some examples, based on this determined time period, the power provider may determine which symbol was transmitted by the power consumer.

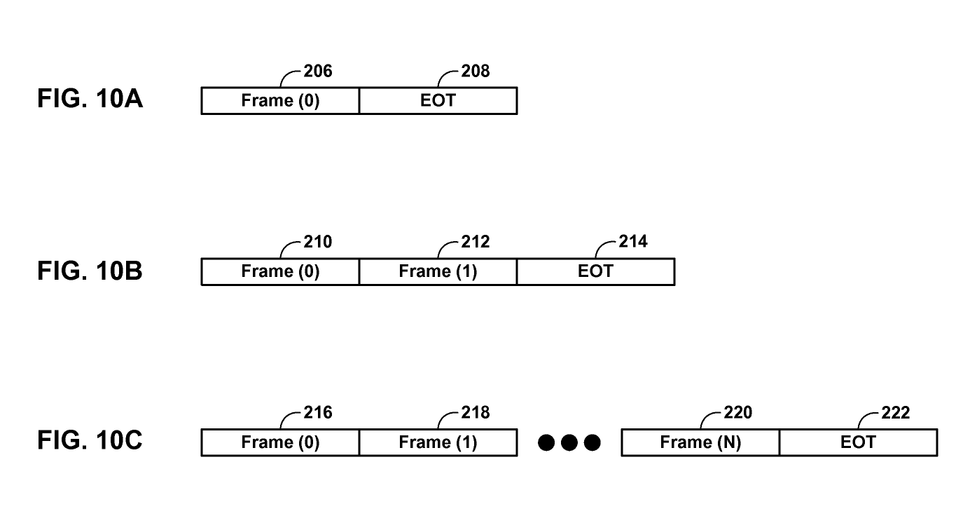

FIGS. 10A-10C are conceptual diagrams illustrating example transmission configurations for inter-device communication over a power line, in accordance with one or more aspects of the present disclosure. As discussed above, in some examples, a power consumer may communicate with a power provider by transmitting a stream of pulses with different timing between the pulses. Also, in some examples, the different timing between the pulses may define one or more symbols such as logic 0, logic 1, end-of-frame, and end-of-transmission.

In some examples, a power consumer may communicate with a power provider by transmitting one or more frames. In some examples, the power consumer may indicate to the power provider that the power consumer has finished transmitting. In the example of FIG. 10A, a power consumer may transmit one frame, such as Frame(0) 206, followed by an end-of-transmission symbol, such as EOT 208. In the example of FIG. 10B, a power consumer may transmit two frames, such as Frame(0) 210 and Frame(1) 212, followed by an end-of-transmission symbol, such as EOT 214. In the example of FIG. 10C, a power consumer may transmit three or more frames, such as Frame(0) 216, Frame(1) 218, . . . , Frame(N) 22,0 followed by an end-of-transmission symbol, such as EOT 222. In some examples, the end-of-transmission symbol may be defined by no communication over 8× a pulse width.

FIG. 11 is a conceptual diagram illustrating an example frame configurations for inter-device communication over a power line, in accordance with one or more aspects of the present disclosure. As illustrated in FIG. 11, example Frame(N) 226 may include sync data 228, data packet 230, and end-of-frame symbol 232.

In some examples, sync data 228 may include four logic zero symbols. In some examples, the end-of-frame symbol may be defined by no communication over 6× a pulse width.

FIG. 12 is a conceptual diagram illustrating further details of one example of a data packet portion of an example frame for inter-device communication over a power line, in accordance with one or more aspects of the present disclosure. As illustrated in FIG. 12, example data packet 230 may include data 236, data check 238, and inversion information 240.

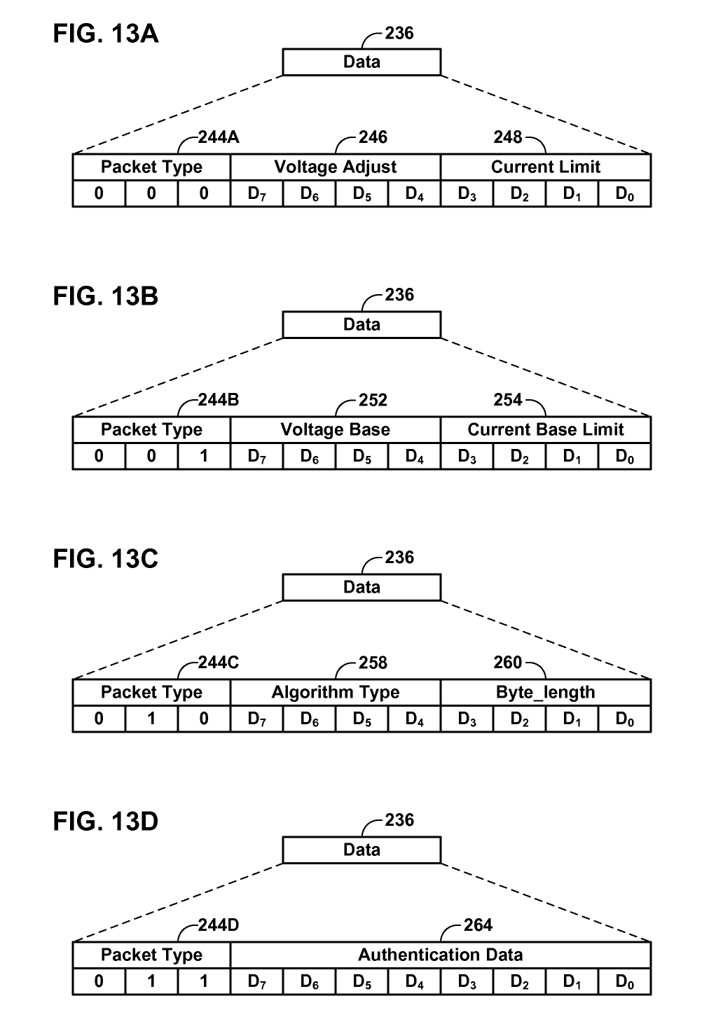

FIGS. 13A-13D are conceptual diagrams illustrating further details of one example of a data portion of an example frame for inter-device communication over a power line, in accordance with one or more aspects of the present disclosure. As illustrated in FIG. 13A, data 236 may include packet type information 244, voltage adjust information 246, and current limit information 248.

In some examples, packet type information 244 may indicate which type of information is included in the remainder of data 236. In the example of FIG. 13A, packet type information of [0,0,0] may indicate that the remainder of data 236 indicates a voltage adjust setting (i.e., voltage adjust information 246) and a current limit setting (i.e., current limit information 248).

In some examples, voltage adjust information 246 may include symbols D₇-D₄. In some examples, in response to receiving voltage adjust information 246, a power provider may adjust the voltage level of the power line. In some examples, voltage adjust information 246 may indicate an offset and/or a multiplier. For instance, voltage adjust information 246 may indicate a request that the power provider change the voltage level of the power line by adding an offset to the base level and/or multiplying the base level by a multiplier. In some examples, in response to receiving voltage adjust information 246 of [0,0,0,0], the power provider may output power on the power line at a base voltage.

In some examples, current limit information 248 may include symbols D₃-D₀. In some examples, in response to receiving current limit information 248, a power provider may adjust the current limit of the power line. In some examples, current limit information 248 may indicate an offset and/or a multiplier. For instance, current limit information 248 may indicate a request that the power provider change the current limit of the power line by adding an offset to the base level and/or multiplying the base level by a multiplier. In some examples, in response to receiving current limit information 248 of [0,0,0,0], the power provider may output power on the power line with a current limit of the base current limit.

In the example of FIG. 13B, packet type information of [0,0,1] may indicate that the remainder of data 236 indicates a voltage base setting (i.e., voltage base information 252) and a current base setting (i.e., current base limit information 254).

In some examples, voltage base information 252 may include symbols D₇-D₄. In some examples, in response to receiving voltage base information 252, a power provider may adjust the base voltage level of the power line. In some examples, in response to receiving voltage base information 252 of [0,0,0,0], the power provider may output power on the power line at a base voltage. In some examples, the base voltage may be 5V.

In some examples, current base limit information 254 may include symbols D₃-D₀. In some examples, in response to receiving current base limit information 254, a power provider may adjust the base current limit of the power line. In some examples, in response to receiving current base limit information 254 of [0,0,0,0], the power provider may output power on the power line with a base current limit. In some examples, the base current limit may be 0.5 A.

In the example of FIG. 13C, packet type information of [0,0,1] may indicate that the remainder of data 236 indicates an algorithm type (i.e., algorithm type 258) and a byte length (i.e., byte length 260). In some examples, bus voltage load modulation may be for a load condition and the controlling firmware may be ROM based (i.e., not controllable via application). However, in some examples, controlling firmware may be programmable which may expose a system to unwanted risk. For instance, a malicious program may be inserted into the system which may inject signaling to raise the voltage and damage or destroy the system. In some examples, it may be desirable to prevent unauthorized tampering with the communication channel. To this end, data illustrated by FIG. 13C and FIG. 13D may be used to secure the communication channel between the power consumer and the power provider.

In some examples, algorithm type 258 may specify which type of algorithm may be used for authentication. For example, in response to receiving algorithm type 258 of [0,0,0,0], a power provider may use an algorithm based on a secure ID. As another example, in response to receiving algorithm type 258 of [0,0,0,1], a power provider may use an algorithm based on a MAC-ID.

In some examples, the byte length may indicate the length of the authentication data. For example, a byte length 260 of [0,0,0,0] may indicate that the authentication data is one byte long. As another example, a byte length 260 of [0,0,0,1] may indicate that the authentication data is two bytes long.

In the example of FIG. 13D, packet type information of [0,1,1] may indicate that the remainder of data 236 indicates authentication data (i.e., authentication data 264). In some examples, authentication data 264 may include a single byte of authentication data. In such examples, the number of packets of type [0,1,1] may be determined based on the value of byte length 260. In some examples, authentication data 264 may indicate the secure ID and/or the MAC-ID of the power consumer. In this way, a power consumer may authenticate with a power provider in order to secure the communication channel between the power consumer and the power provider.

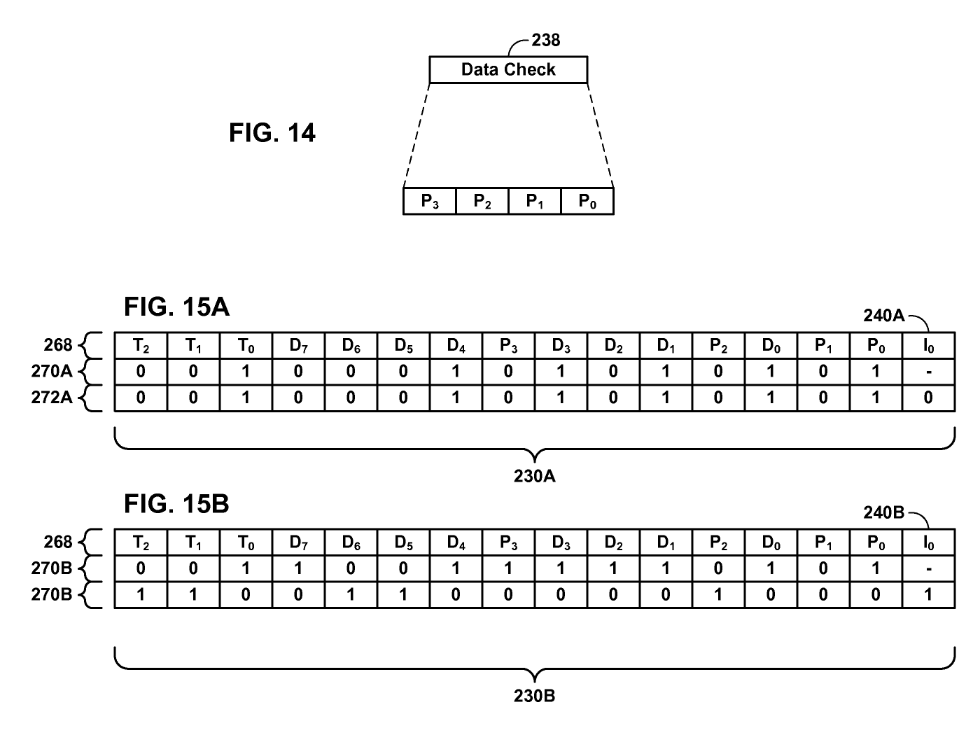

FIG. 14 is a conceptual diagram illustrating further details of a data check portion of an example frame for inter-device communication over a power line, in accordance with one or more aspects of the present disclosure. As illustrated in FIG. 14, data check 238 may include parity bits P₃, P₂, P₁, and P₀. In some examples, the parity bits may include Hamming-15 parity information. In some examples, the parity bits may be based on the values of the other bits included in a data packet. For instance, the parity bits may be based on the values of packet type 244 (i.e., T₂-T₀) and data 236 (i.e., D₇-D₀). In some examples, parity bits P₃, P₂, P₁, and P₀ may be determined according to the following equations (1)-(4).

P₃=T₂̂T₁̂T₀̂D₇̂D₆̂D₅̂D₄ (1)

P₂=T₂̂T₁̂T₀̂D₇̂D₃₆̂D₁̂D₁ (2)

P₁=T₂̂T₁̂T₆̂D₅̂D₃̂D₂̂D₀ (3)

P₀=T₂̂T₀̂T₆̂D₄̂D₃̂D₁̂D₀ (4)

In some examples, by including data check 238, the integrity of the communication channel between the power consumer and the power provider may be improved.

FIGS. 15A and 15B are conceptual diagrams illustrating further details the effects of the inversion bit on the data portion of an example frame for inter-device communication over a power line, in accordance with one or more aspects of the present disclosure.

In some examples, because a logic 0 symbol may take longer to transmit than a logic 1 symbol, a power consumer may invert the bits of a data packet in order to reduce transmission time. For example, a power consumer may invert the bits of a data packet where the number of logic 1 symbols is greater than the number of logic 0 symbols. In some examples, a power consumer may include an inversion bit that indicates whether or not the bits of a data packet are inverted.

In the example of FIG. 15A, row 268 illustrates the identities of the bits to be transmitted, row 270A illustrates the values of the bits to be transmitted, and row 272A illustrates the values of the bits as transmitted. In this example, bits to be transmitted 270A include six logic 1 symbols and nine logic 0 symbols (not including inversion bit 240A). In this example, because it may not be more efficient to invert the symbols, a power consumer may encode inversion bit 240A with a logic 0 to indicate to the power provider that the bits are not inverted. As a result, in this example, a power consumer may transmit bits data packet 230A including bits 272A.

In the example of FIG. 15B, row 268 illustrates the identities of the bits to be transmitted, row 270B illustrates the values of the bits to be transmitted, and row 272B illustrates the values of the bits as transmitted. In this example, bits to be transmitted 270B include nine logic 1 symbols and six logic 0 symbols (not including inversion bit 240A). In this example, because it may be more efficient to invert the symbols, a power consumer may encode inversion bit 240B with a logic 1 to indicate to the power provider that the bits are inverted. As a result, in this example, a power consumer may transmit bits data packet 230B including bits 272B.

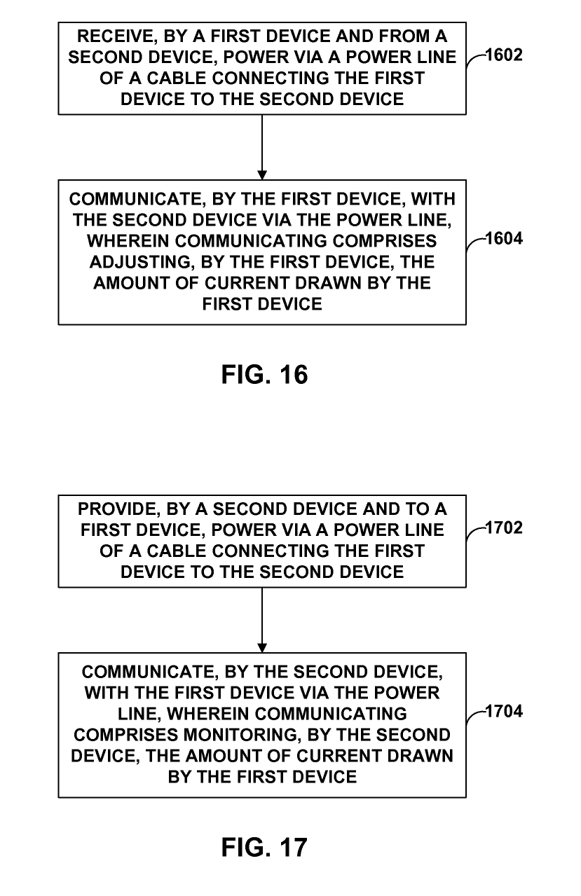

FIG. 16 is a flowchart illustrating example operations of a first device communicating with a second device over a power line using load modulation, in accordance with one or more aspects of the present disclosure. For purposes of illustration, the techniques of FIG. 16 are described within the context of power consumer 6 of FIG. 1, although devices having configurations different than that of power consumer 6 may perform the techniques of FIG. 16.

In accordance with one or more techniques of this disclosure, power consumer 6 may receive, from a second device, power via a power line of a cable connecting power consumer 6 to the second device (1602). Power consumer 6 may also communicate with the second device via the power line, wherein communicating comprises adjusting, by power consumer 6, the amount of current drawn by power consumer 6 (1604).

FIG. 17 is a flowchart illustrating example operations of a second device communicating with a first device over a power line using load modulation, in accordance with one or more aspects of the present disclosure. For purposes of illustration, the techniques of FIG. 17 are described within the context of power provider 4 of FIG. 1, although devices having configurations different than that of power provider 4 may perform the techniques of FIG. 17.

In accordance with one or more techniques of this disclosure, power provider 4 may provide, to a first device, power via a power line of a cable connecting the first device to power provider 4 (1702). Power provider 4 may also communicate with the first device via the power line, wherein communicating comprises monitoring, by power provider 4, the amount of current drawn by the first device (1704).

### Example 1

A method comprising: receiving, by a first device and from a second device, power via a power line of a cable connecting the first device to the second device, wherein receiving power comprises drawing, by the first device, current from the second device; and communicating, by the first device, with the second device via the power line, wherein communicating comprises adjusting, by the first device, the amount of current drawn by the first device.

### Example 2

The method of example 1, wherein adjusting the amount current drawn by the first device comprises: inserting, by the first device, one or more pulses into the amount of current drawn by the power converter.

### Example 3

The method of any combination of examples 1-2, wherein inserting a pulse of the one or more pulses into the amount of current drawn by the first device comprises: drawing, by the first device, a first amount of current; drawing, by the first device, a second, different, amount of current for a pulse width period of time; and after the pulse width period of time, drawing, by the first device, the first amount of current.

### Example 4

The method of any combination of examples 1-3, wherein communicating comprises transmitting at least one symbol of a plurality of symbols, wherein transmitting a symbol of the plurality of symbols comprises: determining a period of time associated with the symbol; inserting a pulse; and after inserting the pulse, maintaining amount of current drawn by the first device for the period of time, wherein each symbol of the plurality of symbols corresponds to a different period of time.

### Example 5

The method of any combination of examples 1-4, wherein communicating comprises transmitting at least one symbol of a plurality of symbols, wherein transmitting a symbol of the plurality of symbols comprises: determining a period of time associated with the symbol; inserting a pulse, wherein the pulse width period of time corresponds to the period of time associated with the symbol, and wherein each symbol of the plurality of symbols corresponds to a different period of time.

### Example 6

The method of any combination of examples 1-5, wherein inserting, by the first device, the one or more pulses into the amount of current drawn by the first device comprises: inserting an error signal into a feedback loop of a power converter of the first device.

### Example 7

The method of any combination of examples 1-6, wherein communicating comprises: sending, by the first device and to the second device, a request to modify one or more characteristics of the power line, wherein the one or more power characteristics for the power line include one or more of: a voltage level for the power line; and a current level for the power line.

### Example 8

The method of any combination of examples 1-7, wherein communicating further comprises receiving, by the first device, data from the second device, wherein receiving data comprises: determining, by the first device, that the second device has provided one or more pulses of power to the first device; determining, based on the one or more pulses of power, one or more symbols.

### Example 9

A power consumer device comprising: a power converter configured to receive power from a power provider device via a power line of a cable connecting the power consumer device to the power provider device, wherein the power converter is configured to receive power by drawing current from the power provider device; and a communication module configured to communicate with the power provider device by adjusting the amount of current drawn by the power consumer device.

### Example 10

The power consumer device of example 9, wherein the communication module is configured to adjust the amount of current drawn by the power consumer device by at least: inserting one or more pulses into the amount of current drawn by the power consumer device.

### Example 11

The power consumer device of any combination of examples 8-10, wherein the communication module is configured to communicate with the power provider device by at least transmitting at least one symbol of a plurality of symbols, wherein the communication module is configured to transmit a symbol of the plurality of symbols by at least: determining a period of time associated with the symbol; drawing a pulse of current from the power provider device; and after drawing the pulse, maintaining the amount of current drawn by the power consumer device for the period of time, wherein each symbol of the plurality of symbols corresponds to a different period of time.

### Example 12

The power consumer device of any combination of examples 8-11, wherein the communication module is configured to communicate with the power provider device by at least: sending, to the power provider device, a request to modify one or more characteristics of the power line, wherein the one or more power characteristics for the power line include one or more of: a voltage level for the power line; and a current level for the power line.

### Example 13

A power consumer device comprising: means for receiving, from a power provider device, power via a power line of a cable connecting the power consumer device to the power provider device, wherein the means for receiving power comprise means for drawing current from the power provider device; and means for communicating, with the power provider device via the power line, wherein the means for communicating comprise means for adjusting the amount of current drawn by the means for drawing current.

### Example 14

The power consumer device of example 13, wherein the means for adjusting the amount of current drawn by the means for drawing current comprise: means for inserting one or more pulses into the amount of current drawn by the power consumer device.

### Example 15

The power consumer device of any combination of examples 13-14, where the means for communicating comprise means for transmitting at least one symbol of a plurality of symbols, wherein the means for transmitting the at least one symbol of the plurality of symbols comprise: means for determining a period of time associated with a symbol of the plurality of symbols; means for drawing a pulse of current from the power provider device; and means for maintaining, after drawing the pulse, the amount of current drawn by the power consumer device for the period of time, wherein each symbol of the plurality of symbols corresponds to a different period of time.

### Example 16

The power consumer device of any combination of examples 13-15, where the means for communicating comprise: means for sending, to the power provider device, a request to modify one or more characteristics of the power line, wherein the one or more power characteristics for the power line include one or more of: a voltage level for the power line; and a current level for the power line.

### Example 17

A method comprising: providing, by a power provider device and to a power consumer device, power via a power line a cable connecting the power consumer device to the power provider device, wherein providing power comprises providing, by a power converter of the power provider device, current to the power consumer device; communicating, by the power provider device, with the power consumer device via the power line, wherein communicating comprises monitoring, by the power provider device, the amount of current drawn by the power consumer device.

### Example 18

The method of example 17, wherein monitoring the amount of current drawn by the power consumer device comprises: determining, by the power provider device, that the power consumer device has drawn one or more pulses of current from the power provider device.

### Example 19

The method of any combination of examples 17-18, wherein determining that the power consumer device has drawn a pulse of the one or more pulses comprises: determining that a first amount of current was drawn by the power consumer device; determining that a second, different, amount of current was drawn by the power consumer device for a pulse width period of time; and determining that, after the pulse width period of time, the first amount of current was drawn by the power consumer device.

### Example 20

The method of any combination of examples 17-19, wherein communicating comprises receiving at least one symbol of a plurality of symbols, wherein receiving a symbol of the plurality of symbols comprises: determining that a pulse of current has been drawn by the power consumer device; determining that another pulse of current was not drawn by the power consumer device for a period of time; and determining the symbol of the plurality of symbols based on the period of time, wherein each symbol of the plurality of symbols corresponds to a different period of time.

### Example 21

The method of any combination of examples 17-20, wherein monitoring the amount of current provided by the power converter comprises: monitoring an error signal of a feedback loop of the power converter.

### Example 22

The method of any combination of examples 17-21, wherein communicating comprises: receiving, by the power provider device and from the power consumer device, a request to modify one or more characteristics of the power line, wherein the one or more power characteristics for the power line include one or more of: a voltage level for the power line; and a current level for the power line, wherein the method further comprises: adjusting, in response to the request, at least one of the one or more characteristics of the power line.

### Example 23

The method of any combination of examples 17-22, wherein communicating comprises transmitting, by the power provider device, data to the power consumer device, wherein transmitting comprises: inserting, by the power provider device, one or more pulses into the amount of power provided by the power provider device.

### Example 24

The method of any combination of examples 17-23, wherein inserting the one or more pulses into the amount of power provided by the power provider device comprises: inserting an error signal into a feedback loop of the power converter of the power provider device.

### Example 25

A power provider device comprising: a power converter configured to provide power to a power consumer device via a power line a cable connecting the power consumer device to the power provider device, wherein the power converter is configured to provide power by at least providing current to the power consumer device; and a communication module configured to communicate with the power consumer device via the power line, wherein the communication module is configured to communicate by at least monitoring the amount of current drawn by the power consumer device.

### Example 26

The power provider device of example 25, wherein the communication module is configured to monitor the amount of current drawn by the power consumer device by at least: determining that the power consumer device has drawn one or more pulses of current from the power provider device.

### Example 27

The power provider device of any combination of examples 25-26, wherein the communication module is configured to communicate by at least receiving at least one symbol of a plurality of symbols, wherein the communication module is configured to receive a symbol of the plurality of symbols by at least: determining that a pulse of current has been drawn by the power consumer device; determining that another pulse of current was not drawn by the power consumer device for a period of time; and determining the symbol of the plurality of symbols based on the period of time, wherein each symbol of the plurality of symbols corresponds to a different period of time.

### Example 28

The power provider device of any combination of examples 25-27, wherein the communication module is configured to communicate by at least: receiving, from the power consumer device, a request to modify one or more characteristics of the power line, wherein the one or more power characteristics for the power line include one or more of: a voltage level for the power line; and a current level for the power line, wherein the communication module is further configured to adjust, in response to the request, at least one of the one or more characteristics of the power line.

Various examples have been described. These and other examples are within the scope of the following claims.

1. A method comprising:
receiving, by a first universal serial bus (USB) device and from a second USB device, power via a power line of a cable connecting the first device to the second device, wherein receiving power comprises drawing, by the first device, current from the second device; and
communicating, by the first device, with the second device via the power line, wherein communicating comprises adjusting, by the first device, the amount of current drawn by the first device.

2. The method of claim 1, wherein adjusting the amount current drawn by the first device comprises:
inserting, by the first device, one or more pulses into the amount of current drawn by the power converter.

3. The method of claim 2, wherein inserting a pulse of the one or more pulses into the amount of current drawn by the first device comprises:
drawing, by the first device, a first amount of current;
drawing, by the first device, a second, different, amount of current for a pulse width period of time; and
after the pulse width period of time, drawing, by the first device, the first amount of current.

4. The method of claim 3, wherein communicating comprises transmitting at least one symbol of a plurality of symbols, wherein transmitting a symbol of the plurality of symbols comprises:
determining a period of time associated with the symbol;
inserting a pulse; and
after inserting the pulse, maintaining the amount of current drawn by the first device for the period of time, wherein each symbol of the plurality of symbols corresponds to a different period of time.

5. The method of claim 3, wherein communicating comprises transmitting at least one symbol of a plurality of symbols, wherein transmitting a symbol of the plurality of symbols comprises:
determining a period of time associated with the symbol;
inserting a pulse, wherein the pulse width period of time corresponds to the period of time associated with the symbol, and wherein each symbol of the plurality of symbols corresponds to a different period of time.

6. The method of claim 2, wherein inserting, by the first device, the one or more pulses into the amount of current drawn by the first device comprises:
inserting an error signal into a feedback loop of a power converter of the first device.

7. The method of claim 1, wherein communicating comprises:
sending, by the first device and to the second device, a request to modify one or more characteristics of the power line, wherein the one or more power characteristics for the power line include one or more of:
a voltage level for the power line; and
a current level for the power line.

8. The method of claim 1, wherein communicating further comprises receiving, by the first device, data from the second device, wherein receiving data comprises:
determining, by the first device, that the second device has provided one or more pulses of power to the first device;
determining, based on the one or more pulses of power, one or more symbols.

9. A power consumer universal serial bus (USB) device comprising:
a power converter configured to receive power from a power provider USB device via a power line of a cable connecting the power consumer device to the power provider device, wherein the power converter is configured to receive power by drawing current from the power provider device; and
a communication module configured to communicate with the power provider device by adjusting the amount of current drawn by the power consumer device.

10. The power consumer device of claim 9, wherein the communication module is configured to adjust the amount of current drawn by the power consumer device by at least:
inserting one or more pulses into the amount of current drawn by the power consumer device.

11. The power consumer device of claim 9, wherein the communication module is configured to communicate with the power provider device by at least transmitting at least one symbol of a plurality of symbols, wherein the communication module is configured to transmit a symbol of the plurality of symbols by at least:
determining a period of time associated with the symbol;
drawing a pulse of current from the power provider device; and
after drawing the pulse, maintaining the amount of current drawn by the power consumer device for the period of time, wherein each symbol of the plurality of symbols corresponds to a different period of time.

12. The power consumer device of claim 9, wherein the communication module is configured to communicate with the power provider device by at least:
sending, to the power provider device, a request to modify one or more characteristics of the power line, wherein the one or more power characteristics for the power line include one or more of:
a voltage level for the power line; and
a current level for the power line.

13. A power consumer universal serial bus (USB) device comprising:
means for receiving, from a power provider USB device, power via a power line of a cable connecting the power consumer device to the power provider device, wherein the means for receiving power comprise means for drawing current from the power provider device; and
means for communicating, with the power provider device via the power line, wherein the means for communicating comprise means for adjusting the amount of current drawn by the means for drawing current.

14. A method comprising:
providing, by a power provider universal serial bus (USB) device and to a power consumer USB device, power via a power line a cable connecting the power consumer device to the power provider device, wherein providing power comprises providing, by a power converter of the power provider device, current to the power consumer device;
communicating, by the power provider device, with the power consumer device via the power line, wherein communicating comprises monitoring, by the power provider device, the amount of current drawn by the power consumer device.

15. The method of claim 14, wherein monitoring the amount of current drawn by the power consumer device comprises:
determining, by the power provider device, that the power consumer device has drawn one or more pulses of current from the power provider device.

16. The method of claim 15, wherein determining that the power consumer device has drawn a pulse of the one or more pulses comprises:
determining that a first amount of current was drawn by the power consumer device;
determining that a second, different, amount of current was drawn by the power consumer device for a pulse width period of time; and
determining that, after the pulse width period of time, the first amount of current was drawn by the power consumer device.

17. The method of claim 16, wherein communicating comprises receiving at least one symbol of a plurality of symbols, wherein receiving a symbol of the plurality of symbols comprises:
determining that a pulse of current has been drawn by the power consumer device;
determining that another pulse of current was not drawn by the power consumer device for a period of time; and
determining the symbol of the plurality of symbols based on the period of time, wherein each symbol of the plurality of symbols corresponds to a different period of time.

18. The method of claim 14, wherein monitoring the amount of current provided by the power converter comprises:
monitoring an error signal of a feedback loop of the power converter.

19. The method of claim 14, wherein communicating comprises:
receiving, by the power provider device and from the power consumer device, a request to modify one or more characteristics of the power line, wherein the one or more power characteristics for the power line include one or more of:
a voltage level for the power line; and
a current level for the power line,
wherein the method further comprises:
adjusting, in response to the request, at least one of the one or more characteristics of the power line.

20. The method of claim 14, wherein communicating comprises transmitting, by the power provider device, data to the power consumer device, wherein transmitting comprises:
inserting, by the power provider device, one or more pulses into the amount of power provided by the power provider device.

21. The method of claim 20, wherein inserting the one or more pulses into the amount of power provided by the power provider device comprises:
inserting an error signal into a feedback loop of the power converter of the power provider device.

22. A power provider universal serial bus (USB) device comprising:
a power converter configured to provide power to a power consumer USB device via a power line a cable connecting the power consumer device to the power provider device, wherein the power converter is configured to provide power by at least providing current to the power consumer device; and
a communication module configured to communicate with the power consumer device via the power line, wherein the communication module is configured to communicate by at least monitoring the amount of current drawn by the power consumer device.

23. The power provider device of claim 22, wherein the communication module is configured to monitor the amount of current drawn by the power consumer device by at least:
determining that the power consumer device has drawn one or more pulses of current from the power provider device.

24. The power provider device of claim 22, wherein the communication module is configured to communicate by at least receiving at least one symbol of a plurality of symbols, wherein the communication module is configured to receive a symbol of the plurality of symbols by at least:
determining that a pulse of current has been drawn by the power consumer device;
determining that another pulse of current was not drawn by the power consumer device for a period of time; and
determining the symbol of the plurality of symbols based on the period of time, wherein each symbol of the plurality of symbols corresponds to a different period of time.

25. The power provider device of claim 22, wherein the communication module is configured to communicate by at least:
receiving, from the power consumer device, a request to modify one or more characteristics of the power line, wherein the one or more power characteristics for the power line include one or more of:
a voltage level for the power line; and
a current level for the power line,
wherein the communication module is further configured to adjust, in response to the request, at least one of the one or more characteristics of the power line.
